(19) United States
(12) Patent Application Publication
(10) Pub. No.: US 2015/0097827 A1
(43) Pub. Date: Apr. 9, 2015

(54) Target Region Fill Utilizing Transformations

(71) Applicant: Adobe Systems Incorporated, San Jose, CA (US)

(72) Inventors: Scott D. Cohen, Sunnyvale, CA (US); Brian L. Price, San Jose, CA (US); Bryan S. Morse, Mapleton, UT (US); Joel A. Howard, Provo, UT (US)

(73) Assignee: Adobe Systems Incorporated, San Jose, CA (US)

(21) Appl. No.: 14/050,163

(22) Filed: Oct. 9, 2013

(51) Int. Cl. G06T 17/10

(52) U.S. Cl. CPC G06T 17/10; G06T 2200/04; G06T 2207/20048
USPC 345/420

(57) ABSTRACT

Target region fill techniques involving transformations are described. In one or more implementations, a patch to be used to fill a target region in an image of an scene is identified. A transformation to be applied to the patch is guided using depth information of the scene and at least a portion of the target region in the image is filled using the transformed patch.

### BACKGROUND

Image editing techniques are becoming increasingly popular as the pervasiveness of image capture devices continues to increase. A user, for instance, may carry a mobile phone having a digital camera, a tablet computer, dedicated camera, and so on to capture an image of an scene, e.g., landscape, room, sporting event, and so on. A user may then employ image editing techniques to modify the image as desired.

One such example of an editing technique is commonly referred to as “hole filling” which may be used to fill a target region in an image. Accordingly, hole filling may be used to support removal of objects from an image, such as to remove a person from the image, repair an image, and so on. To perform this technique, a hole created by removing the object is filled, which is typically based on areas of the image that lie “outside” the hole.

However, conventional hole filling techniques could generate inaccuracies in the image, which could be noticeable to a user. Further, these inaccuracies may be magnified in some instances, such as when used in stereoscopic images such that images modified using these conventional techniques could cause the stereoscopic images to fail for their intended purpose.

### SUMMARY

Target region fill techniques utilizing transformations are described. In one or more implementations, a patch is identified that is to be used to fill a target region in an image of an scene. A transformation to be applied to the patch is guided using depth information of the scene and at least a portion of the target region in the image is filled using the transformed patch.

In one or more implementations, a system includes at least one module implemented at least partially in hardware, the at least one module configured to compute depth information of an scene using disparities computed from stereoscopic images. The system also includes one or more modules implemented at least partially in hardware, the one or more modules configured to fill at least a portion of a target region in one or more of the stereoscopic images using a patch that is transformed based at least in part of the computed depth information.

In one or more implementations, one or more computer-readable storage media comprise instructions stored thereon that, responsive to execution by one or more computing devices, causes the one or more computing devices to perform operations. The operations includes guiding a transformation to be applied to a patch using depth information of an scene and filling at least a portion of a target region in an image of the scene using the transformed patch.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein involving target region filling.

FIG. 2 depicts a system in an example implementation in which images are captured of an scene and used to fill a target region.

FIG. 3 depicts an example of operation of a patch-matching algorithm.

FIG. 4 is an illustration of examples that include results from an algorithm without transformations and also with extensions to include use of transformations.

FIG. 5 is an illustration of an image that includes a target region showing use of anchor points for identification of source patches that are to be used to fill the target region.

FIG. 6 is an illustration showing use of a transformation to a candidate patch and offset to a neighboring patch.

FIG. 7 is a flow diagram depicting a procedure in an example implementation in which a patch is identified and transformed using depth information.

FIG. 8 is a flow diagram depicting a procedure in an example implementation in which depth information is computed using disparities computed from stereoscopic images and used to guide a transformation to a patch to be used to fill a target region.

FIG. 9 illustrates an example of disparity maps.

FIGS. 10-14 are illustrations of techniques in which a target region is filled after removal of an object from stereo images in which a disparity map is also filled.

FIG. 15 is an example of a graffiti removal target filling technique in which depth information is retained.

FIGS. 16-25 are illustrations of techniques in which a target region is filled after removal of an object in which a patch is transformed, the transformation guided at least in part using depth information.

FIG. 26 illustrates an example system including various components of an example device that can be implemented as any type of computing device as described and/or utilize with reference to FIGS. 1-25 to implement embodiments of the techniques described herein.

### DETAILED DESCRIPTION

### Overview

As consumer-grade stereo cameras become increasingly common, users desire an ability to edit stereo images in ways that are conventionally employed for individual images. Consequently, this may introduce challenges of maintaining stereoscopic fidelity between the edited images. However, this may also introduce a new set of opportunities to take advantage of additional information that may be obtained from a pair of images.

An example of one technique that may be used to edit images involves replacement of target regions of an image with content by intelligently drawing from the rest of the image surrounding the target region, which is commonly referred to as hole filling. A variety of different techniques were conventionally employed to perform this replacement on single images. However, these conventional techniques may cause inconsistencies when applied to stereo images, thereby causing the stereo images to fail for their intended purpose, e.g., to support stereoscopic vision.

Accordingly, techniques are described herein that may be employed for target region filling that may be employed for stereo images as well as for images individually. In an implementation, techniques are described which involve completion of target regions that includes use of transformations (e.g., scaling, rotations, sheering) that may be guided using depth information, such as disparities, a depth sensor, and so on. For example, a patch may be selected from a different depth in an image than a target region that is to be filled. Depth information may therefore be leveraged to select an amount of scaling that is to be performed for the patch to be used as part of the fill. Additional techniques may also be leveraged as part of this hole filing, such as to give preference to downscaling as opposed to upscaling and non-scaled transformations, and so on as further described in the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures. Although the following discussion at times describes stereoscopic implementations, these techniques may also be applicable to single images as well as a plurality of images that are not stereoscopic. This may include multiple images of the same scene (e.g., a particular landmark), multiple images having a matching object in different scenes (e.g., a car photographed at different locations), and so forth.

### Example Environment

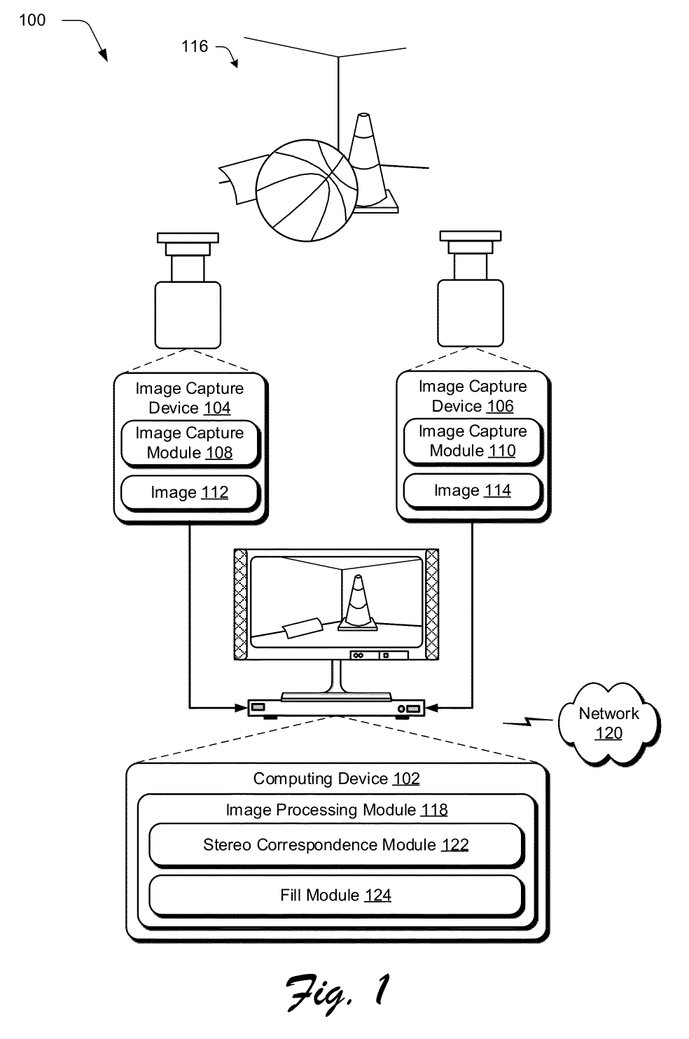

FIG. 1 is an illustration of an environment 100 in an example implementation that is operable to employ techniques described herein. The illustrated environment 100 includes a computing device 102 and a plurality of image capture devices 104, 106, which may be configured in a variety of ways.

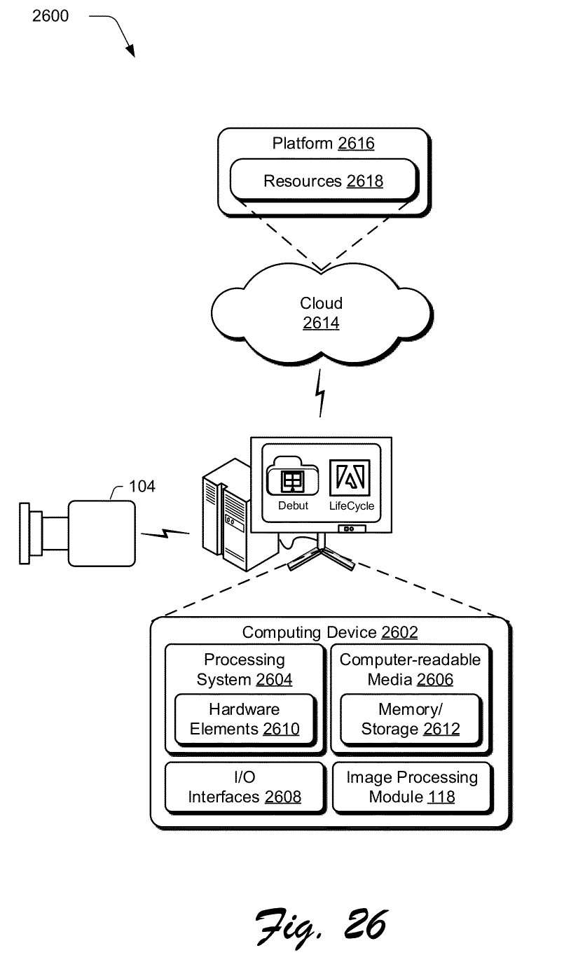

The computing device 102, for instance, may be configured as a desktop computer, a laptop computer, a mobile device (e.g., assuming a handheld configuration such as a tablet or mobile phone), and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices, such as multiple servers utilized by a business to perform operations “over the cloud” as further described in relation to FIG. 26.

The image capture devices 104, 106 may also be configured in a variety of ways. Illustrated examples of such configurations include a standalone camera such as a dedicated device, part of a mobile phone or tablet, and so on. Other examples are also contemplated. For example, each of the image capture devices 104, 106 may be configured as a single stereoscopic camera, scanner, copier, camera, mobile device (e.g., smart phone), and so forth. In another example, a single image capture device 104 may be used to capture multiple images of an scene, such as the basketball, cone, and piece of paper in the room as illustrated.

The image capture devices 104, 106 are illustrated as including a respective image capture module 108, 110. The image capture modules 108, 110 are representative of functionality to capture respective images 112, 114, such as by including image sensors and other hardware and software components to capture, process, and/or store images 112, 114.

The images 112, 114 in this example are stereoscopic in that the images are taken from different viewpoints of the illustrated scene 116. For example, the images 112, 114 may be viewable by a user to gain a perception of three dimensional depth of the scene. The images 112, 114 may also be usable to model the scene in three dimensions, such as to determine depth at various locations. This may be performed in a variety of ways as further described below.

The computing device 102 is illustrated as including an image processing module 118. The image processing module 118 is representative of functionality to perform one or more techniques that are usable to process an image. Although illustrated as implemented locally on the computing device, functionality of the image processing module may also be implemented in a distributed environment, remotely via a network 120 (e.g., “over the cloud”) as further described in relation to FIG. 26, and so on.

An example of image processing that may be performed by the image processing module 118 is represented as a stereo correspondence module 122. The stereo correspondence module 122 is representative of functionality to generate stereo correspondence data, which may describe which pixels in stereoscopic images correspond to each other and which may be expressed as a disparity. The stereo correspondence module 112, for instance, may process images 112, 114 to determine depth of the scene 116 to perform three dimensional modeling, perform view synthesis, view interpolation, content manipulation, matting (e.g., object removal), support augmented reality (e.g., object insertion), and so on. Other examples are also contemplated, such as to capture images 112, 114 that are not stereoscopic, but still provide different views of the scene 116.

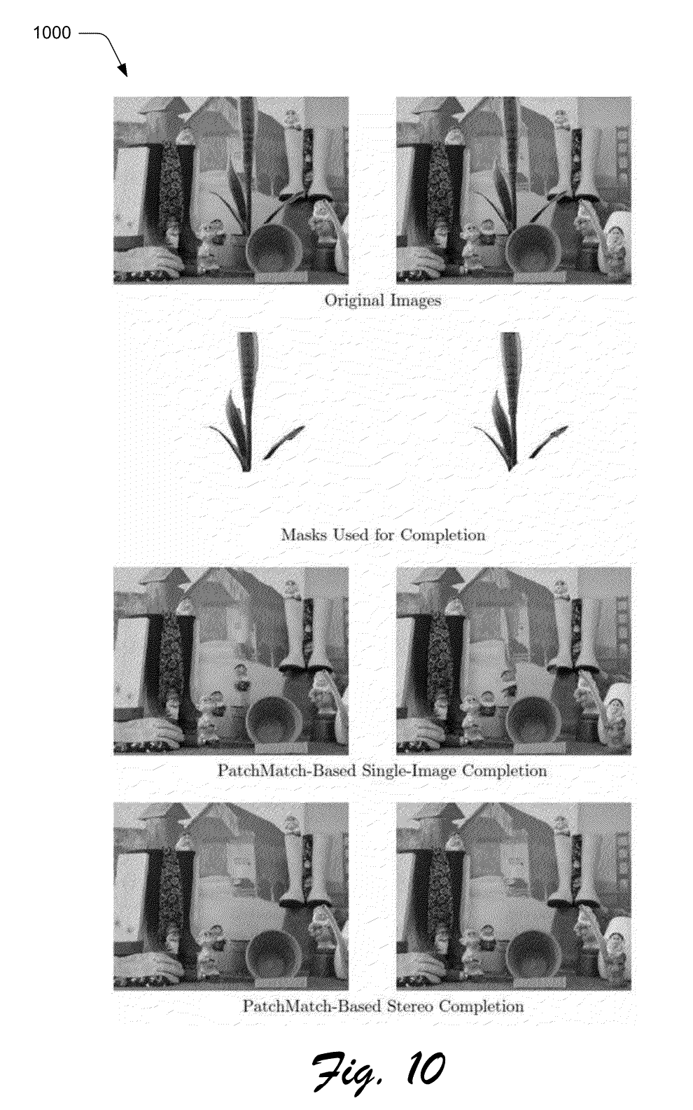

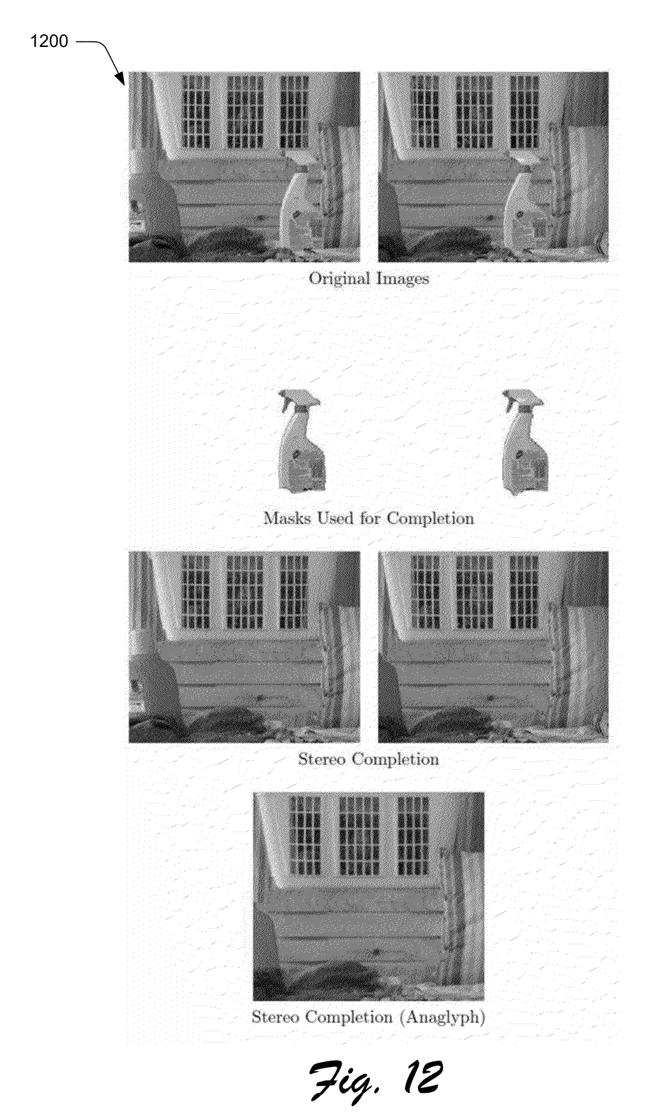

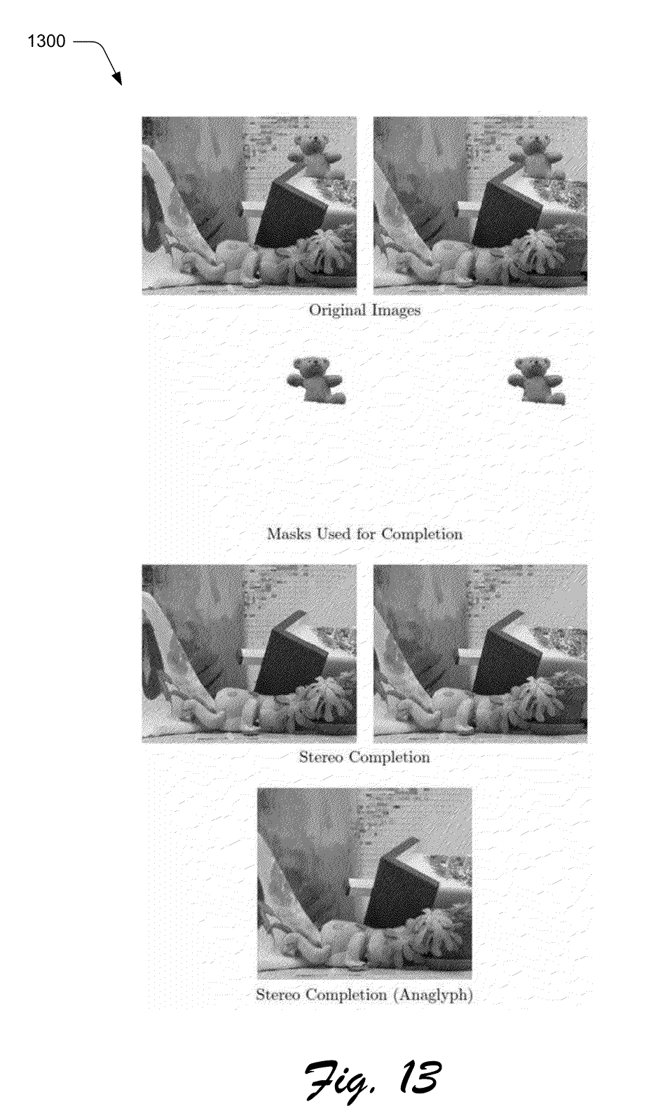

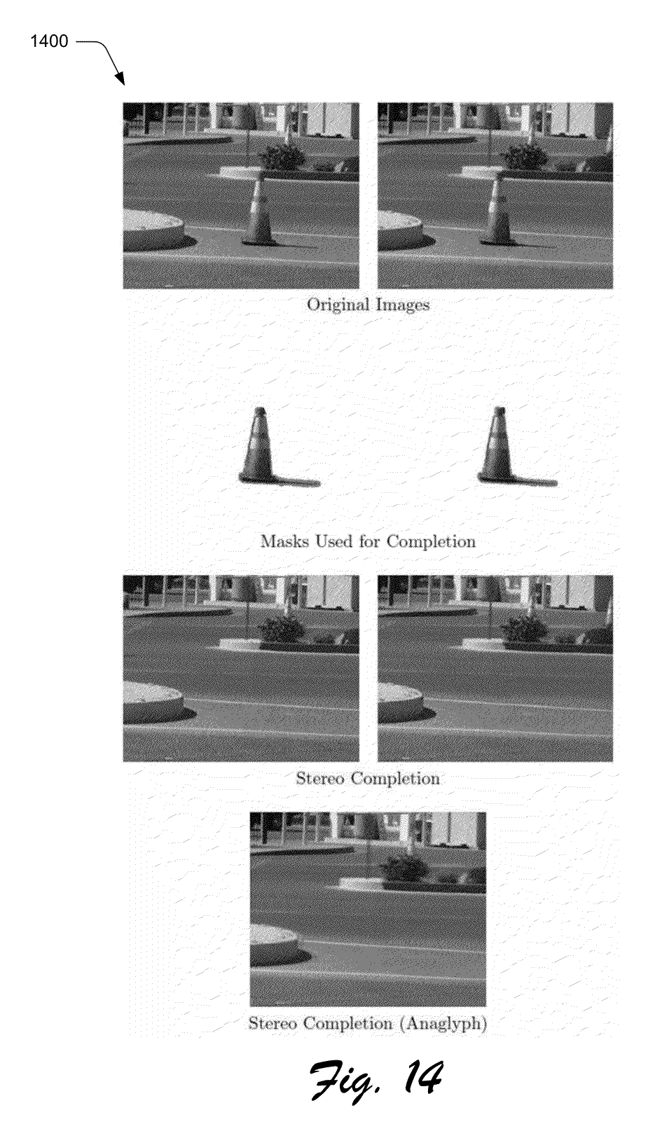

Another example of image processing that may be performed by the image processing module 118 is represented as a fill module 124. The fill module 124 is representative of functionality to fill a target region in one or more of the images 112, 114. For example, the fill module 124 may be used to support object removal from one or more of the images 112, 114, such as to remove the basketball from the images 112,114 as shown in the user interface output by the display device of the computing device 102 in the figure. Other examples 1000-2500 are also shown in relation to FIGS. 10-25. These techniques may also be used for a variety of other purposes, such as to fill a portion in an image that is missing, e.g., due to occlusion, errors, and so on. This processing may be performed in a variety of ways, further description of which may be found in the following discussion and corresponding figure.

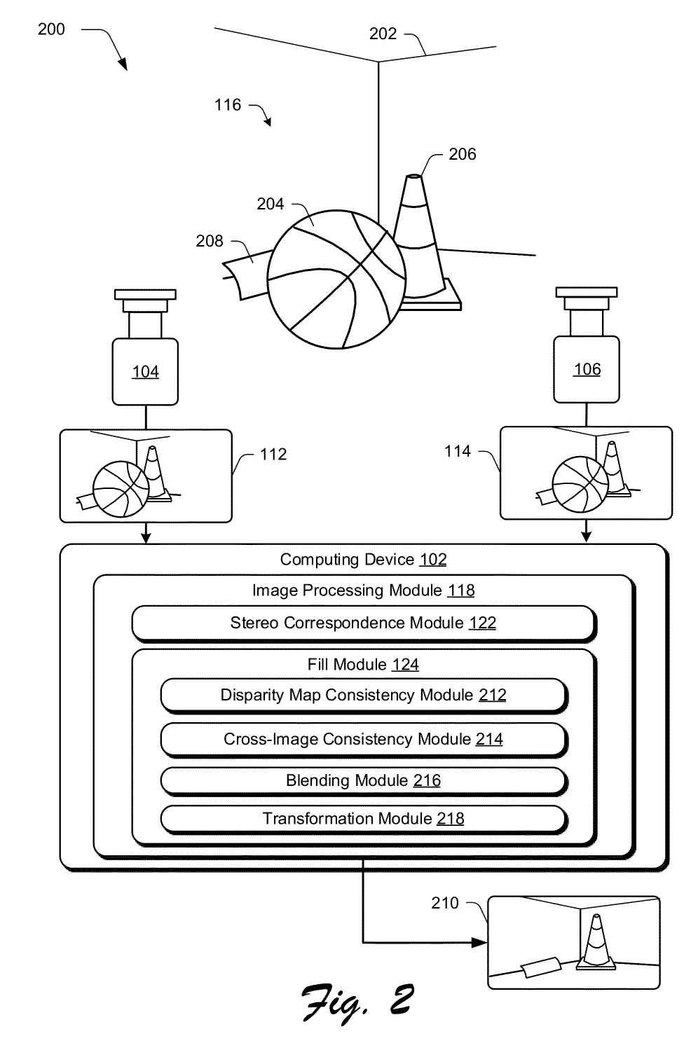

FIG. 2 depicts a system 200 in an example implementation in which images 112, 114 are captured of an scene 116 and used to fill a target region. The scene 116 is illustrated as showing a room 202 having a basketball 204, a traffic cone 206, and a piece of paper 208. The image capture devices 104, 106 are illustrated as capturing images 112, 114 of the scene 116, which may be stereoscopic or non-stereoscopic as further described below. In a stereoscopic implementation, the images may be leveraged for a variety of purposes, such as for three dimensional modeling, view interpolation, and so on.

To support this example, the image processing module 118 may employ the stereo correspondence module 122 to compute stereo correspondence data that describes which pixels in the images 112, 114 correspond to each other, such as to include disparity maps and textures to be employed by the respective images 112, 114. This data may be leveraged to support a wide variety of functionality.

The fill module 124, for instance, may leverage this functionality to “fill in” a target region of an image. One or more of the images 112, 114 for instance, may be processed by the fill module 124 to remove an object from the image, such as to remove the basketball 204 to generate the image 210 as shown in the figure.

While stereoscopic consistency may be a challenge, especially in target region filling, the availability of additional depth information from stereo pairs or other related images (e.g., different images of the scene 116 that are not configured to support a stereoscopic view) may be used to increase accuracy in performing this operation.

The available depth information, for instance, may be used to provide an additional dimension of information for creating a patch (e.g., a completion) that is consistent with expectations of a human eye. Depth information may be obtained in a variety of other ways, such by using a depth sensor that is configured to output data that describes depth of the scene 116 at different locations, through computation of stereo correspondence, and so on.

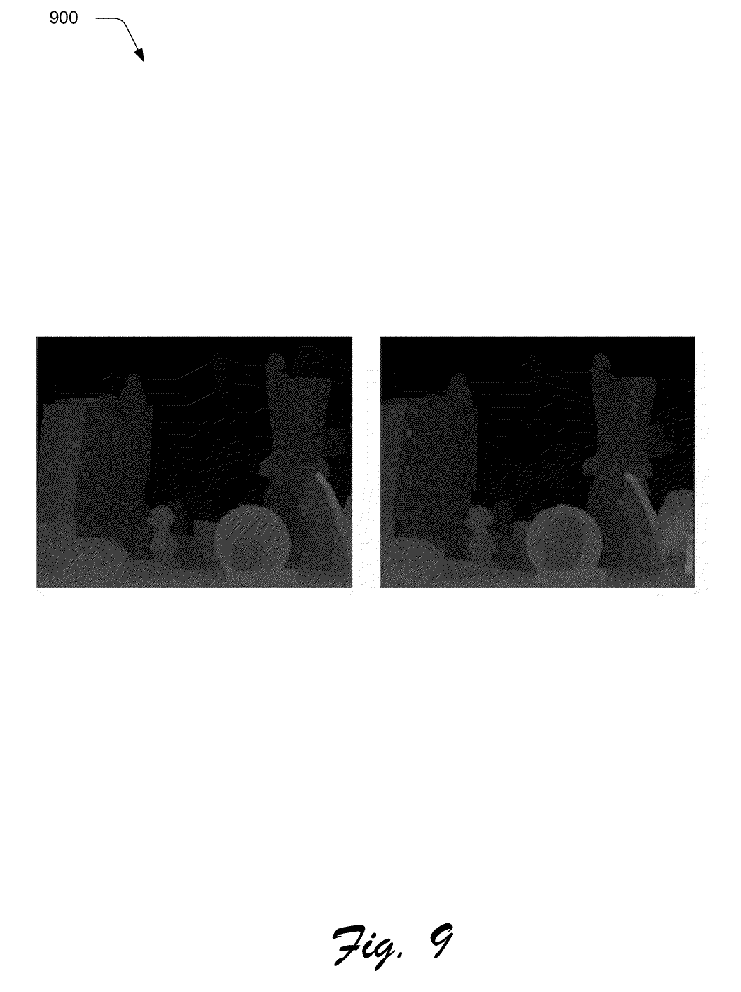

Regardless of how originated, the depth information may be leveraged in a variety of different ways. For example, a technique may be employed to pre-fill disparity maps in a way that maintains mutual consistency as shown in the example 900 of FIG. 9, thus allowing the respective disparity estimates to aid further matching and blending. This may be performed by sharing information involved in the computations, such that a computation to arrive at a first patch for a first image may leverage information used in the computation of a second patch for a second image. This functionality is represented as disparity map consistency module 212 in the figure.

In another example, techniques may be supported that provide for cross-image search and depth-sensitive comparison to both a target region and a stereo-corresponding target region in another image. This may also be performed by sharing information involved in the computations such that information involved in the computations may involve different patches for different images. This functionality is represented as a cross-image consistency module 214 in the figure.

In a further example, techniques are described that involve an extension to a weighted blending of matched target region patches that give preference to strong stereo correspondence at desired disparities. This functionality is represented as a blending module 216 in the figure. Further, computation involved in the filling of the target regions in the disparity maps and the filling of the respective stereoscopic images using the color texture may be performed such that information involved in the computations is shared, e.g., information is propagated between the calculations for the respective regions.

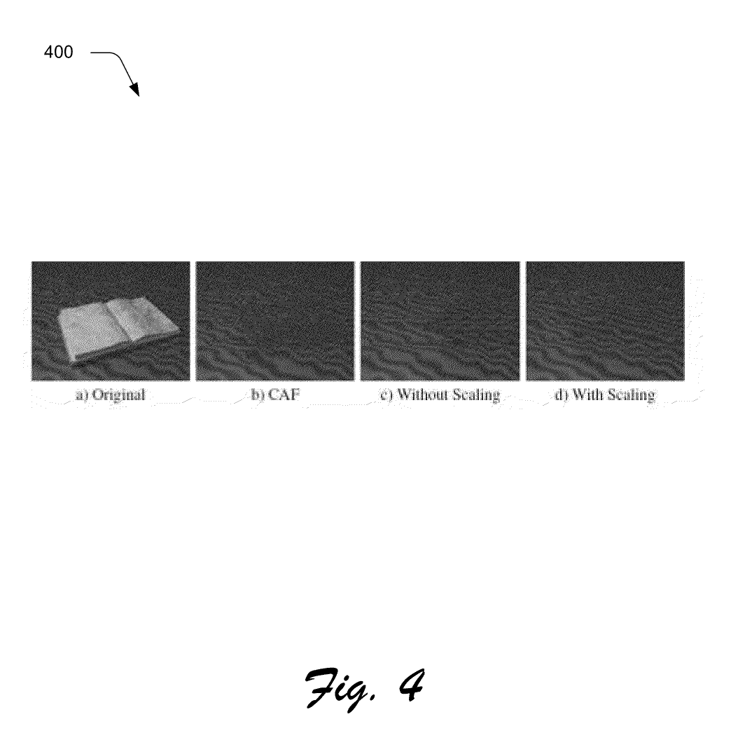

In yet another example, techniques may be employed that support transformations that may be applied to an identified patch to fill a target region. For example, a patch may be identified from a portion of an image that may be used as fill for a target region in that image and/or in another image as described above. Depth information may be used to guide this transformation, such as to perform scaling, change a perspective (e.g., in accordance with a three dimensional understanding of an scene of the image as indicated by the depth information), and so on. This functionality is represented as a transformation module 218 in the figure, further discussion of which may be found in a corresponding section below and discussion beginning in conjunction with FIG. 4.

Thus, a system may be supported that may be used to promote coherence of respective target regions with respect to the rest of the source images 112, 114 while also maintaining stereoscopic consistency. This may be performed to match patches in a way that allows for cross-image copying in the case of regions that are originally partially-occluded without involving an explicit pre-copying step. This allows loosely marked masks that are independent such that the masks include non-corresponding pixels to be handled gracefully without requiring correspondence in the two images.

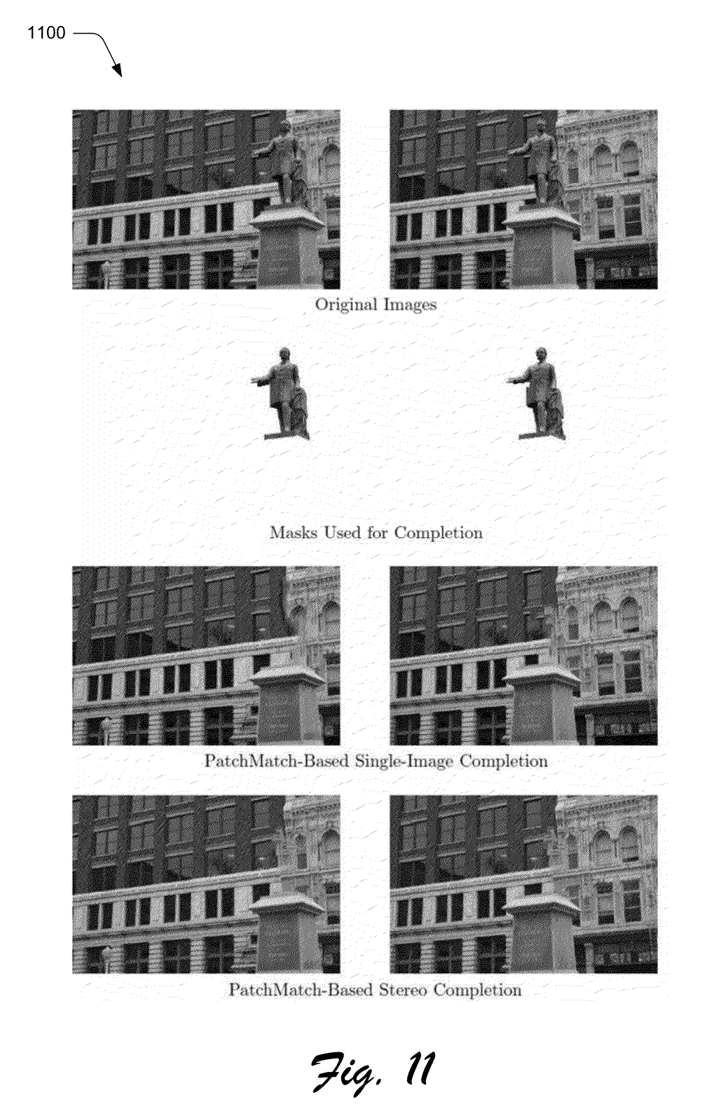

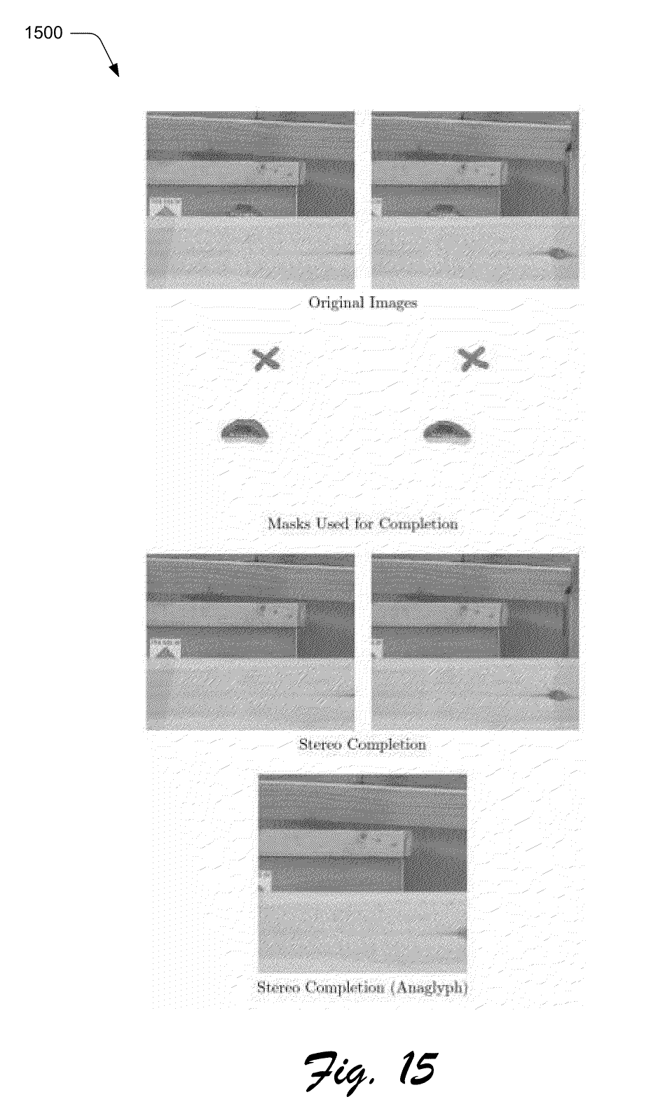

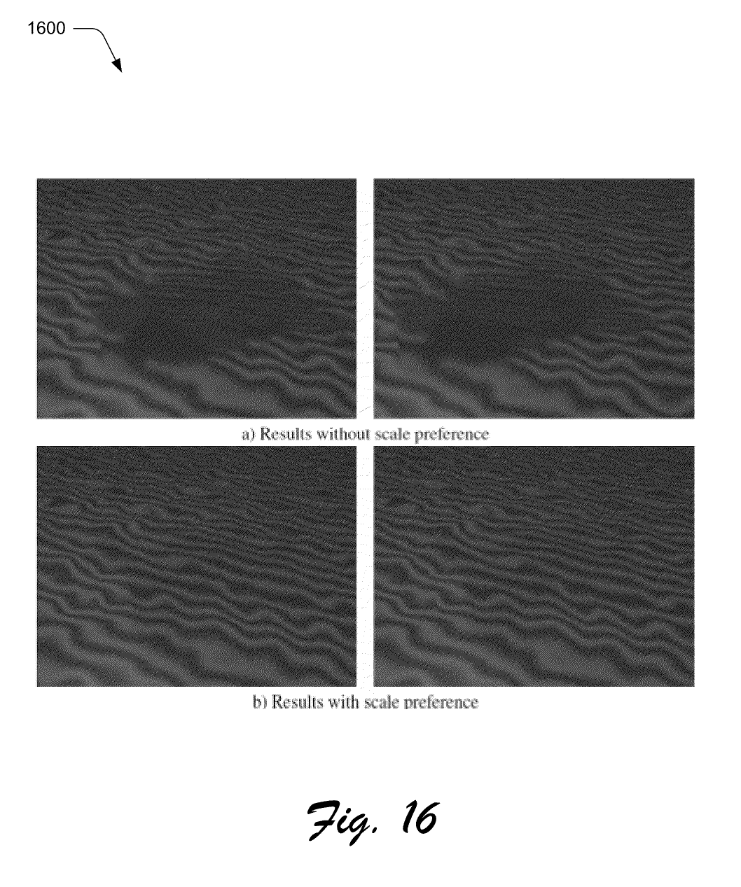

This technique may also handle removal and replacement of texture on a three dimensional object (e.g., a wall of the room 202 or other surface as shown in the example 1500 of graffiti removal in FIG. 15), removal of an entire object such as the basketball 204 in FIG. 2 as well as the examples 1100-1400 of FIGS. 11-14, examples involving transformations as shown in relation to FIGS. 16-25, and so on. Thus, the use of depth information may support techniques to fill a target region with accuracy that is increased with respective to conventional single-image completion techniques. Although the following discussion uses stereo images in a variety of different examples, it should be readily apparent that these techniques may also leverage images that are not stereoscopic, such as different views of an scene that would not support a stereoscopic view when viewed by a user, may involve an object located in different scenes, and may also be performed to generate a single image.

In one or more implementations, techniques are described that may leverage a single image patch-matching based completion approach, also referred to as a “Patch-matching Algorithm” in the following discussion. For example, the following measure of image coherence may be minimized:

$${d}_{total} ( S , T ) = {\sum }_{t ∈ T} {min}_{s ∈ S} d ( s , t )$$

where “T” is a target region, “S” is a source region (e.g., an area of the image outside of the target region), and “tεT” and “sεS” are patches within target and source regions, respectively. The expression “d(s,t)=∥s−t∥₂²” is a measure of a difference between patches “s” and “t”. Intuitively, this is used to ensure that each patch within a filled region is similar to a corresponding patch in the rest of the image such that artifacts introduced that would not match patches in the rest of the image are penalized.

Thus, this expression is satisfied when two conditions are met at each point “p.” In the first condition, each of the patches “tεT” that overlap point “p” have an exact match “sεS”, and hence “d(s,t)=0.” In the second condition, each of the patches “tεT” overlapping “p” agree on a value at “p” such that the blended results of the patches do not introduce additional error. Thus, an energy/magnitude style approach may be taken by iteratively alternating between matching each target patch “tεT” to its best match “sεS”, blending of the resulting patches is used to synthesize the content in the target region to fill the region.

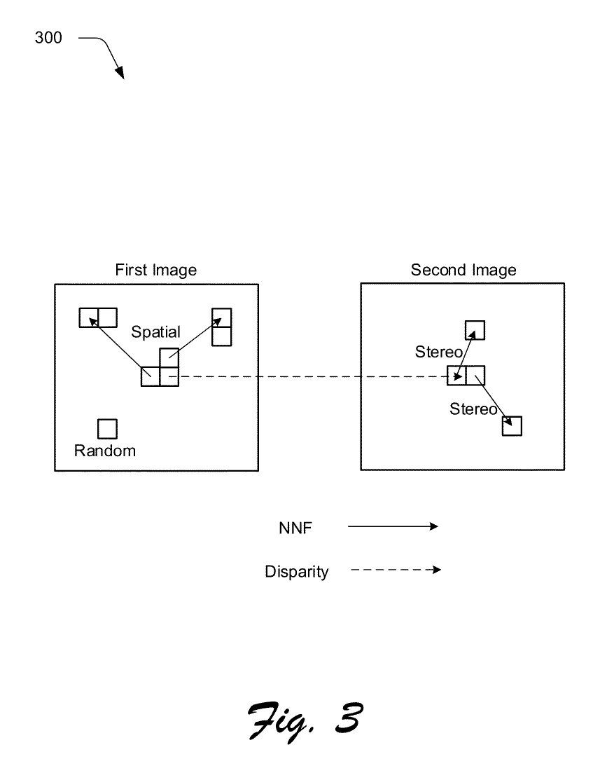

The patch-matching based approach may avoid exhaustive search by leveraging spatial propagation of matches and random search to support efficient techniques for finding good matches shown in the example 300 of FIG. 3. For example, a “nearest neighbor field” (NNF) technique may be employed, which may provide a mapping from each patch in an image to a corresponding best (so far) match outside the target region, which may be denoted as “s=NNF(t).”

Additionally, techniques may be employed to update “best matches” and then blend the matches into the target region. This may be performed by weighting each blended patch by a monotonically decreasing function of the distance from the patch to the boundary of the target region. This may help drive content into the target region from the outside of the region. Additionally, a gradual-resizing approach may be used to create a multi-scale pyramid. At a coarsest scale of the pyramid, diffusion filing may be used to initialize a patch-matching based energy/magnitude iteration. For subsequent scales, the NNF from a previous scale may be up sampled, examples of which are further described in relation to the following sections.

Stereo Image Completion

A stereo pair of images 112, 114 may be configured in a variety of ways. For purposes of the following discussion, these images 112, 114 are treated as four-valued “RGBD” images in which “D” is a disparity. Additionally, the images 112, 114 may have been rectified by the image processing module 118 and stereo correspondence computed by the stereo correspondence module 112. A user may then provide a mask specifying one or more target regions as shown in the examples 1000-1500 of FIGS. 10-15. This may be performed in a variety of ways, such as by manual selection through interaction with a stereo-based selection tool, use of a cursor control device, gesture, through automatic selection by a module (e.g., of a foreground object), and so forth.

Disparity maps as shown in the example 900 of FIG. 9 may have characteristics that are quite different than those of respective color images. Unlike color images with rich texture, for instance, disparity maps generally involve smooth regions with strong spatial structure, qualities that may be exploited in algorithms for computing stereo disparity, e.g., by the stereo correspondence module 122. In one or more implementations, the target regions of the disparity maps are filled first. The disparity maps may then be used to guide selection of source patches to complete a target region's color texture.

Target region filling may be leveraged for a variety of purposes. For example, filling may be used to remove entire foreground objects as previously described in the example of the basketball. Other examples include removal of three-dimensional structural detail on a larger object, such as a wall and so on in an image as shown in the examples 1000-1400 of FIGS. 1000-1400. In another example, physical structure of the scene 116 may be retained, but a target region may be used to replace texture on an object, which may be referred to as “graffiti removal” as shown in the example 1500 in FIG. 15 and which may also be used to adjust and remove shadows and so on. Thus, implementations are contemplated in which a user may specify whether to fill disparities in a target region or to retain and use the original disparity maps. A stereoscopically consistent texture may then be synthesized based on these disparities are further described below.

Depth Completion

In this example, two disparity maps “D_{L}” and “D_{R}” are described which refer to left and right images, respectively. These two disparity maps may be used to handle depth information in half-occluded regions as described below. Prior to use, holes in the disparity maps may be filled by the stereo correspondence module 122 using a “smaller hole” variation of the techniques described in this section.

In one or more implementations, partial differential equation (PDE) based in-painting techniques may be used to recover a smooth spatial structure in the disparity maps. For example, in-painting of a single disparity map “D” may involve the following iteratively solved PDE:

$$\frac{\partial }{\partial t} D = ∇ L \cdot {∇}_{⊥} D$$

where L=∇²D denotes the described 2D Laplacian of the disparity map. Intuitively, this PDE is used to propagate image curvature along image level curves, thus filling regions and preserving edge structure. To reduce the number of iterations involved for numerical implementation of the above expression, the target region may be initialized using a diffusion-based fill. The diffusion into the target region may be limited to disparities smaller (i.e., more distant) than the original content in the region.

As previously described, conventional techniques that were employed for images singly could cause artifacts that were viewable between stereoscopic images. Accordingly, techniques are described in which target filling is used in which stereoscopic consistency is enforced. For example, a weak consistency constraint may be used as part of the expression of the iteratively solved PDE above.

Values in disparity maps, e.g., “D_{L}” and “D_{R}”, may be characterized on a point-by-point basis in the images as follows:
Consistent and viewable in both images:

D_{L}(x,y)=D_{R}(x−D_{L}(x,y),y)

D_{R}(x,y)=D_{L}(x+D_{R}(x,y),y)
Half-occluded such that an object is viewable in one image but occluded in another:

D_{L}(x,y)<D_{R}(x−D_{L}(x,y),y) or

D_{R}(x,y)<D_{L}(x+D_{L}(x,y),y)
Physical inconsistency, e.g., physically impossible to be occluded from behind:

D_{L}(x,y)>D_{R}(x−D_{L}(x,y),y) or

D_{R}(x,y)>D_{L}(x+D_{R}(x,y),y)

Thus, the expression of the iteratively solved PDE above may be modified to create a pair of coupled PDEs that include in-painting of respective disparity maps as well as additional terms that promote mutual consistency and therefore stereoscopic consistency as follows:

$$\frac{\partial }{\partial t} {D}_{L} = ∇ {L}_{L} \cdot {∇}_{⊥} {D}_{L} + {λ}_{{ρ}_{L}}$$

$$\frac{\partial }{\partial t} {D}_{R} = ∇ {L}_{R} \cdot {∇}_{⊥} {D}_{R} + {λρ}_{R}$$

where “L_{L}” is a Laplacian of “D_{L}”, and “L_{R}” is a Laplacian of “D_{R}”, and

$${ρ}_{L} ( x , y ) = \{ \begin{matrix}{D}_{R} ( x - {D}_{L} ( x , y ) , y ) - {D}_{L} ( x , y ) & if {D}_{R} ( x - {D}_{L} ( x , y ) , y ) - {D}_{L} ( x , y ) < ε \\ 0 & otherwise\end{matrix} \\ {ρ}_{R} ( x , y ) = \{ \begin{matrix}{D}_{L} ( x + {D}_{R} ( x , y ) , y ) - {D}_{R} ( x , y ) & if {D}_{L} ( x - {D}_{R} ( x , y ) , y ) + {D}_{R} ( x , y ) < ε \\ 0 & otherwise\end{matrix}$$

are the consistency terms, with “ε” controlling the tolerance. If the above expression describing consistency for the values in the disparity maps applies at a given pixel to within “ε” tolerance (e.g., less than or equal to a tolerance of “1” or other value), an assumption may be made that the disparities are to be consistent. Therefore, these disparities may be adjusted to increase similarity as desired.

On the other hand, if the half-occluded characterization above applies at a given pixel greater than “ε” tolerance, an assumption may be made that the pixels are involved in a “half occlusion” and therefore the differing disparities are retained. Further, if the inconsistency characterization above applies, the disparity maps may be adjusted to correct this physical inconsistency.

Texture Matching and Synthesis

To synthesize texture over the respective disparity maps of the images 112, 114 to perform the “completion” shown in FIGS. 10-15, the objective function described above may be broadened to allow for the drawing of source textures from either image, penalize stereo mismatches between the images, and so on. For example, let “S_{L}” and “S_{R}” denote source regions in left and right images, respectively, and similarly let “T_{L}” and “T_{R}” denote respective target regions. Also, let “C_{LR}(t)” denote mapping from patch “t_{L}εT_{L}” centered at “(x, y)” to a corresponding patch “t_{R}εT_{R}” centered at “(x−D_{L}(x, y), y).” To simplify further notation in the following discussion, “C(t)=C_{LR}(t)” is used for patches in the left image and “C(t)=C_{RL}(t)” is used for patches in the right image, respectively.

Optimization of stereo-filling coherence may therefore be defined as a minimization of the following objective function:

$${d}_{total} ( {S}_{L} , {S}_{R} , {T}_{L} , {T}_{R} ) = {\sum }_{t ∈ {T}_{L} ⋃ {T}_{R}} {min}_{s ∈ {S}_{L} ⋃ {S}_{R}} d ( s , t ) + {\sum }_{t ∈ {T}_{L}} d ( t , {C}_{LR} ( t ) ) + {\sum }_{t ∈ {T}_{R}} d ( t , {C}_{RL} ( t ) )$$

Here, the patch-difference measure “d(s,t)” may be redefined to be a mean squared difference between the RGBD values of the patches. Other patch distances and ways of incorporating depth and/or disparity are also contemplated.

The first term is similar to the above expression regarding the image coherence measure and encourages coherent filling of the target regions in the respective images. It should be noted that the matching of patches across the two images is explicitly allowed in this example, thereby providing a richer set of source patches.

The additional two terms in the expression above encourage stereo consistency by penalizing patches that exhibit visual dissimilarity at the relevant disparity. While this likewise does not immediately imply an algorithm for optimization, the energy/magnitude approach of the pair of coupled PDEs above that is designed to promote mutual consistency may be extended. This extension may be performed based two observations. First, that the objective function for stereo-filling coherence is minimized if both of the conditions identified above for minimizing the measure of image coherence are met. Second, the objective function for stereo-filling coherence is minimized if each of the pixels in the target regions are filled with content that exactly matches a corresponding patch in the other image at the relevant disparity. This may be true unless such content would not be visible in the other image, i.e., half occluded. To encourage this, the patch-blending step of the energy/magnitude process may be modified to give increased weight to patches that are stereo-consistent, unless occluded in the other image. The patch-matching search may also be expanded to include patches from both images, including a propagation step designed to facility stereo consistency.

Stereo Patch Matching

Because the two source images provide a larger set of source patches than either image alone, and because some useful patches may be visible in one image but not in the other, the patch-matching algorithm may be extended to include cross-image searching as previously described. The patch-matching algorithm may use two parts to search for better patches than currently found, an example 300 of which is shown in FIG. 3. The first is a propagation step, in which the neighbors of patches matched to those neighboring the current patch are considered as “spatial” examples. For example, the current NNF matches for the neighbors of “t” are considered to update “NNF(t)”. The second involves a random search step shown as “random” in the figure.

As shown in the example implementation 300 of FIG. 3, this may be extended to include a stereo-correspondence step, in which the stereo-corresponding patch in the other image is considered, e.g., for patch “C(t)” which is illustrated as “stereo” in the figure. Thus, this may also include a stereo propagation step, in which matches found for the neighbors of the corresponding patch “C(t)” are considered. In one or more implementations, inclusion of the current values for the stereo-corresponding patch in the other image “C(t)” is the only time matching is allowed between a target patch to a patch that is inside or overlaps either target region.

This inclusion in the expanded search allows for copying (and subsequent blending) of patches that have been found in the other image, leading to minimization of the latter two terms of the stereo-filling coherence objective function above. It should be noted that the stereo-corresponding patch is still selected as the best-corresponding patch during the patch-matching process, which ultimately allows the image for which the best completion is found to dominate the other, weaker solution. It is also possible that during this stereo-correspondence part of the search the corresponding patch is part of the source region, and not the target region, for the other image. This may happen when removal of a foreground object dis-occludes a region in one image that is visible in the other image. Conventional techniques relied heavily by explicitly warping originally half-occluded data, however the techniques described herein may be performed without an explicit copying pre-step. Further, cross-image copying may happen automatically as part of the searching and synthesis process in these techniques.

In addition to the spatial propagation step of the patch matching algorithm referenced above, a stereo propagation step may also be included. The stereo propagation step may be used to expand the pool of candidate source patches further to include not only the corresponding patch “C(t)” in the other image, but the current best matches to “C(t)” according to the other image's NNF. Due to sub-pixel disparities, which are present in the multi-scale hierarchy even if the original disparity maps use only integer disparities, this means searching two possible candidates using the floor and ceiling of the x coordinates of “C(t).”

Stereo-Consistent Patch Blending

Once the nearest-neighbor field is updated using the extended patch-matching algorithm above, a “patch voting” operation may be performed to blend the source patches and fill the target region. In order to promote stereo consistency, increased blending weight may be given to those patches that are consistent with their stereoscopic counterparts in the other image. For example, the blending weight of pixels in patch “t” may be a function of the similarity between “t” and the stereo-corresponding patch “C(t).”

The color “c” of a particular target pixel “p,” for instance, may be calculated using a weighted blending of the values of the source patches “s” matched to each target patch “t” that overlaps pixel “p,” in a manner similar to the mutual consistency expression described above. For example, let “{t¹, t², . . . t^{k}}” denote a set of patches overlapping pixel “p,” whether entirely inside the target region “T” or not. Also, let “{s¹, s², s^{k}}” denote respective best matches for the patches. If “cⁱ” is used to denote the color for pixel “p” as suggested by the source patch “Sⁱ” and weight “wⁱ” denote the weight given to patch “tⁱ”, the color “c” for pixel “p” is given by the weighted blending:

$$c = \frac{{\sum }_{i} {w}^{i} {c}^{i}}{{\sum }_{i} {w}^{i}}$$

The weights “wⁱ” are a combination of two factors. The first factor is the same as the one used for single-image filling as described for the conventional patch-matching algorithm above. The second factor is an additional factor that penalizes stereoscopic mismatches as follows:

wᵢ=w_{d}ⁱwₛⁱ

The distance-based weight “w_{d}ⁱ” may be calculated by:

w_{d}ⁱ=γ^{-(dist(p}^{ⁱ}^{,T)}

where “dist(pⁱ, T)” is a distance from “pᵢ” (the center of patch “tⁱ”) to a boundary of a target region “T”, or “0” if “pᵢ” lies outside of “T.” In one or more implementations, a value of γ=1.3 is used.

The stereoscopic-consistency weight “wₛⁱ” is given by comparing un-occluded parts of patch “tⁱ” to a (possibly sub-pixel) counterpart in the other image as follows:

$${w}_{s}^{i} = {e}^{\frac{- {\text{?}}_{s} ( {t}^{i} , C ( {\text{?}}^{\text{?}} )}{2 {σ}_{c}^{2}}}$$

$$\text{?} \text{indicates text missing or illegible when filed}$$

The occlusion-respecting patch squared difference “ [symbol] ” is calculated as the mean squared difference between the mutually un-occluded portions of the patches “tⁱ” and “C(tⁱ)”, again which may support sub-pixel comparison. If the entire patch “tⁱ” is occluded from view in the other image (i.e., there is no corresponding “C(tⁱ)”), “ [symbol] ” is set to a maximum of “3·255²” to give a minimal but non-zero weight in the blending. This has the effect of causing half-occluded regions to be filled from the un-occluded side, thereby giving a stronger weight to the contributions from un-occluded neighboring patches. Within the half-occluded region, however, these patches each have the same (albeit low) weight, which effectively removes the effect of this weighting factor from the weights “wⁱ” above through normalization of the weighted blending. In one or more implementations, a value of “σ_{c}=7” is used.

Depth-Guided Target Region Filling Transformations

This section presents an extension of the above patch-matching algorithm by extending the algorithm to search for and find scaled versions of source patches. In the algorithm of described above, the texture of each target patch is compared with its prospective source patch along with corresponding three dimensional structure. This comparison, achieved by comparing absolute disparities, effectively limits the potential source patches the algorithm can draw from to those of similar depth. This produces desirable results when applied to stereo images of frontoparallel surfaces (no depth difference between the surfaces), in many cases avoiding drawing texture from unsuitable areas. It can also work well when applied to surfaces that are not frontoparallel (have varying distances) so long as there is sufficient suitable source texture for each distance. Similarly, it may not work well even for frontoparallel surfaces when areas of suitable source texture are found on other surfaces at distances other than that of the target. To address these two issues, we extend our previous algorithm to incorporate source patches scaled appropriately according the relative distances between the source and target regions.

With the use of stereo images, and their inherent 3D information, estimating the correct scaling between two patches can be done directly. Application of an estimation technique may also mitigate selection of random scales when searching for potential source patches, allowing the algorithm to converge faster.

In the following discussion, operation of the transformation module 218 of FIG. 2 is described which may be configured to estimate patch-to-patch scaling to extend the above patch-matching algorithm to be able to intelligently draw from scaled textures by leveraging 3D information to estimate the scale instead of performing an entirely random search. An example 400 in shown in FIG. 4 that includes results from the patch-matching algorithm above without transformations and also with extensions to include use of transformations, e.g., scaling in this example. These techniques may also be configured to address non-uniform scale transformations, e.g., different scales in the “x” and “y” directions, to address image foreshortening along planes and other complications.

Depth information, such as disparity information obtained from stereo images, may be leveraged to identify a 3D structure contained in an scene 116. By leveraging this information, a patch search may be guided towards improved possible matches, which may even be used to eliminate use of a random search of an entire space of an image as described above.

Given real-world coordinates (or at least real-world depth) of two objects in a scene, an estimate the relative projected scaling “φ_{t,s}” between two objects may be obtained by using a ratio of corresponding depths:

$${ϕ}_{\text{?} , \text{?}} = \frac{{z}_{s}}{{\underline{z}}_{t}}$$

$$\text{?} \text{indicates text missing or illegible when filed}$$

where “zₜ” is the depth of the target patch and “zₛ” is the depth of the source patch. Stereo disparities are inversely proportional to depth as follows:

zₚ=fB/dₚ

where “zₚ” is the real world depth (or distance from the camera) at pixel “p,” “dₚ” is the disparity at pixel “p,” “f” is the focal length of the camera, and “B” is the baseline (or horizontal distance) between the two cameras (assuming a canonical configuration). It should be noted that although disparity can be estimated, using one of any number of algorithms, the focal length and baseline cannot be estimated without prior knowledge or camera calibration. For this reason, the depth of each pixel may be estimated up to some unknown scale factor.

Using the estimated depth, the scaling factor may be estimated between two patches. Substituting “f B/dₚ” for the “z” values in the above equation and simplifying results in the following expression:

$${ϕ}_{\underline{t , s}} = \frac{{d}_{t}}{{\underline{d}}_{s}}$$

Notice that the unknown scale factors “f” and “B” cancel out. Thus, the scale between any two patches may be estimated by using a ratio of their disparities.

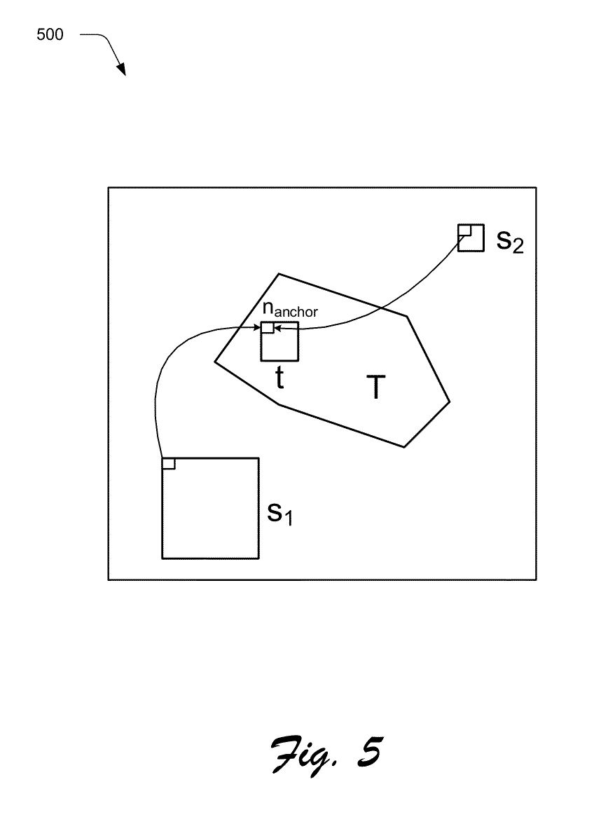

As illustrated in the example 500 in FIG. 5, an anchor point (i.e., a reference point) may be used to estimate the parameters for an entirety of a patch. In other words, an assumption may be made that one pixel of the patch, (e.g., the top left in the illustrated implementation) is reminiscent of the entire patch.

In this example 500, scaled patches are shown which are determined by the disparity computed from a stereo image pair. The example 500 includes a disparity map and example scaled source patches for a given target patch. A source patch “S₂” is shown as being up-sampled because it is further from the camera than a target region “t” while source patch “S₁” is down sampled because it is closer to the camera. The scale factors “φ” between the source and target patches are determined by the disparities of the anchor positions (top left hand pixel of the patch). In one or more implementations, the scale factor “φ” may be different in the “x” direction than in the “y” direction, i.e., “φₓ” and “φ_{y}” might not be equal.

Although disparities computed from the stereo images may be used to provide an initial estimate of the scale between two patches, a search around the estimated scale may still be performed. For example, computed disparities may not be accurate due to the nature of the computation. Additionally, algorithms may not calculate sub-pixel disparities in some examples, which may introduce slight errors even if the disparity is correctly computed. Accordingly, the algorithm may be altered to randomly search in a window of scales around the originally estimated scale, thus allowing the algorithm to refine the estimated scales.

Instead of arbitrarily picking a fixed range of scales around the estimate, disparities of the target and source patches may be used to intelligently guide and determine a reasonable range of scales, in which, to perform a search, which may be performed as follows:

$${S}_{window} = [ \frac{\text{?} + δ}{\text{?} - δ} , \frac{\text{?} - δ}{\text{?} + δ} ]$$

$$\text{?} \text{indicates text missing or illegible when filed}$$

where “δ” is the range of expected error values in the disparity map. For example, assuming correct disparity maps up to whole integer values, “δ” would be 1 to account for sub-pixel disparities. Thus, the range of scales is greater for patches that are farther away (where even slight errors in the disparities can greatly affect the computed scale transformation) and smaller for closer patches, where slight errors matter much less.

This windowed search may be accomplished by limiting the range of scales the algorithm can randomly choose when considering a specific target and source patch pair. Thus, the estimated scale may be used to focus the algorithm on more plausible, and in all likelihood better, scales.

One of the steps involved in the Patch-matching algorithm described above involves the propagation of good matches found in the random search phase to neighboring pixels, taking advantage of the inherent structure of images. However, introduction of new transformations into the algorithm may complicate this phase slightly as neighboring patches are no longer related by a simple translation, thereby involving transformation of the relative offsets between neighboring patches. To put it another way, good matches were propagated by following an assumption that a good candidate for a given target patch “t” is an offset of “t's” neighbor's current best nearest neighbor. With uniform frontoparallel transformations (i.e., translation only), the offset is the difference between “t” and its neighbor. When adding other types of transformations, however, the offset also reflects this, i.e., a rotated source patch will rotate its neighbor with it.

This issue may be addressed as follows. For example, let “T(NNF(x))” be the full transformation defined by “(x; y; φ)” where “x” and “y” are the translations in the “x” and “y” directions, respectively, and “φ” is a uniform scale factor. The propagated candidate is then as follows:

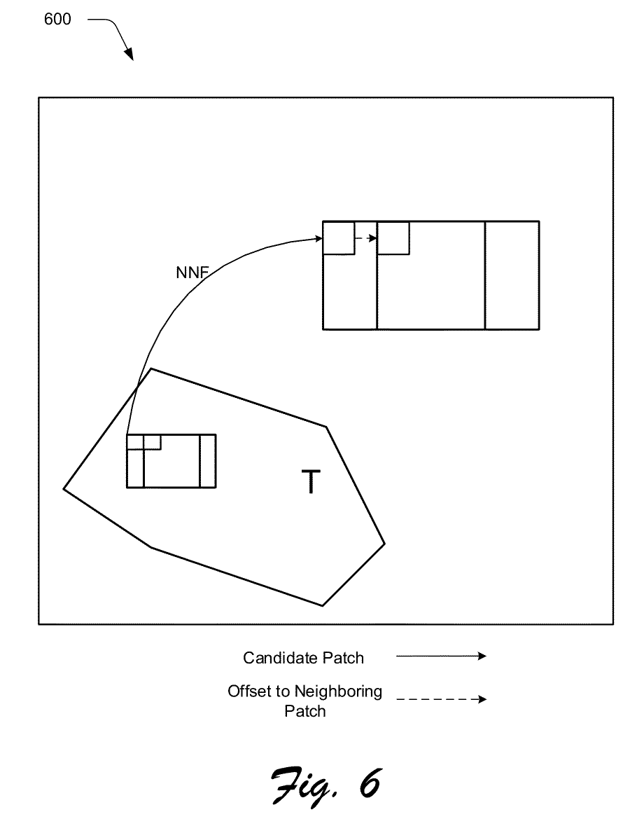

NNF(x−Δp)+T′(NNF(x−Δp))Δp

where “Δp” is the difference in position of the target patch and its neighbor. In simpler terms, and illustrated in the example 600 in FIG. 6, the target's transformation is applied to the neighbor's position, giving a potential patch that is correctly offset and oriented from the source patch, i.e. producing the source's neighbor according to the specified transformation. It should be noted that the source's neighbor inherits each of the parameters (aside from translation) from the source patch. In this case, this means that the scale is also propagated. The computed scale may also be used at the propagated translation to add another potential source patch to the candidate pool.

The assumption of uniform scale is valid when the surface being drawn from is frontoparallel to the camera. As soon as the plane is slanted, the farther portions of the plane are foreshortened due to the perspective warp which occurs during image acquisition. The more slanted the plane, the worse the foreshortening. Accordingly, this foreshortening is not modeled by uniform scale transformations, particularly when target and source patches lie on differently-slanted planes. Rather, this foreshortening may be approximated by non-uniform scale transformations. As such, the random search phase may be expanded to include non-uniform scale transformations.

This may be accomplished by decomposing the uniform scale factor “φ” into two separate directional scale factors for different axes, “φ” and “φ_{y}.” and expanding the transformation space to “(x, y, φₓ, φ_{y}).” Though this does add another dimension to the search space, the previous optimizations described above may be applied by estimating the horizontal scale “φₓ” as the uniform scale factor was estimated. That is, the disparities from horizontally offset cameras may be used to estimate the scale between the source and target patches and determine a reasonable search window around that scale. A vertical scale “φ_{y}” is then determined for each candidate “φₓ” by randomly choosing an aspect ratio “θ_{xy}” and applying that to “φₓ” as follows:

φ_{y}=θ_{xy}φₓ

Thus, the methodology of the extensions described previously is followed but, once again, the algorithm is focused to more plausible, and in all likelihood better, scale factors. The range of possible aspect ratios may be limited to reasonable values (e.g., between half and double size) to avoid extreme foreshortening of the source patches.

To perform target region filling, a decision is made as to which source material is to be blended into the target region. For patch-based techniques, this involves choosing source patches that match the current target patches in the hole based on a selected similarity metric, which is a simple sum of the squared difference (SSD) of RGB channels. In the above discussion, depth information such as image disparity is introduced into the similarity metric to allow the algorithm to not only compare the potential source patch's texture but its 3D structure as well. However, simply matching disparities as above folds depth into the metric, thereby limiting the depths considered by the algorithm.

To address this, absolute depth from the similarity metric is removed when considering scaled patches, but may include comparison of local relative-depth structure. This may be accomplished by normalizing the disparities or other depth information according to the disparity at the given patch's anchor point as follows:

d′ₙ[i]=dₙ[i]−dₙ[n_{anchor}]

where “dₙ[i]” is the disparity of patch “n” at position “i” and “n_{anchor}” is “n's” anchor position. This transforms the disparity to be relative to its current patch anchor, thereby removing the inherent depth information while preserving the encoded 3D structure. Including this as part of the disparity distance metric results in the following expression:

$${\overline{D}}_{d} = {\sum }_{i} {( {d}_{t}^{′} [ i ] - {φ}_{x} {d}_{s}^{′} [ i ] )}^{2}$$

which compares the relative structure of the target and source patches without preferring similar depths. Note that “d's” is scaled by “φₓ” or the horizontal scale factor between “t” and “s.” Because of the inverse proportionality of disparity and depth, a difference of one at lower values of disparity is greater than a difference of one at higher values when converted to depth. To emulate this behavior, the target is scaled relative disparity by the horizontal scale factor which encodes the relative scaling between the two patches.

To better understand the intuition of this scale factor and to reduce computation, the above equation may be substituted above and simplified as follows:

$$\begin{matrix} \begin{matrix}{\overline{D}}_{d} = {\sum }_{i} {( ( {d}_{t} [ i ] - {d}_{t} [ {t}_{anchor} ] ) - \frac{{d}_{t} [ {t}_{anchor} ]}{{d}_{s} [ {s}_{anchor} ]} ( {d}_{s} [ i ] - {d}_{s} [ {s}_{anchor} ] ) )}^{2} \\ = {\sum }_{i} {( {d}_{t} [ i ] - {d}_{t} [ {t}_{anchor} ] - \frac{{d}_{t} [ {t}_{anchor} ]}{{d}_{s} [ {s}_{anchor} ]} \text{?} [ i ] + {d}_{t} [ {t}_{anchor} ] )}^{2} \\ = {\sum }_{i} {( {d}_{t} [ i ] - \frac{{d}_{t} [ {t}_{anchor} ]}{{d}_{s} [ {s}_{anchor} ]} {d}_{s} [ i ] )}^{2} \\ = {\sum }_{i} {( {d}_{t} [ i ] - {φ}_{x} {d}_{s} [ i ] )}^{2}\end{matrix} & \\ \text{?} \text{indicates text missing or illegible when filed} & \end{matrix}$$

Note that the anchor disparities fall out, thereby leaving a comparison of the target disparity with a relatively scaled source disparity. This shows movement of the source patch to a matching depth as a target patch in a scene, with the disparities adjusted accordingly by the relative scale. In this way, the relative 3D structure may be compared instead of a 3D location, up to some scale factor.

In some instances, use of the patch-matching algorithm to perform either directed or undirected searches for source patches at any scale may produce large flat or washed out regions in the resulting fill, an example 1600 of which is shown in relation to FIG. 16. As shown in this example 1600, there are washed out regions along the left side of the fill as well as blurred lines along the top of the fill. These are both caused by extreme upsampling in this example, but are not present when using a penalty for such extreme upsampling as shown in (b) in the example 1600. This may be caused because the patch-matching algorithm uses a simple sum-of-the-squared-distance metric to measure the similarity between a given source and target patch. This metric, though in general a good measure, has no real concept of texture. Thus, a flat source patch whose color is close to the average color of a less textured target patch is selected over a similarly textured source patch that has more color variation, driving the solution to have (possibly less appealing) large flat regions.

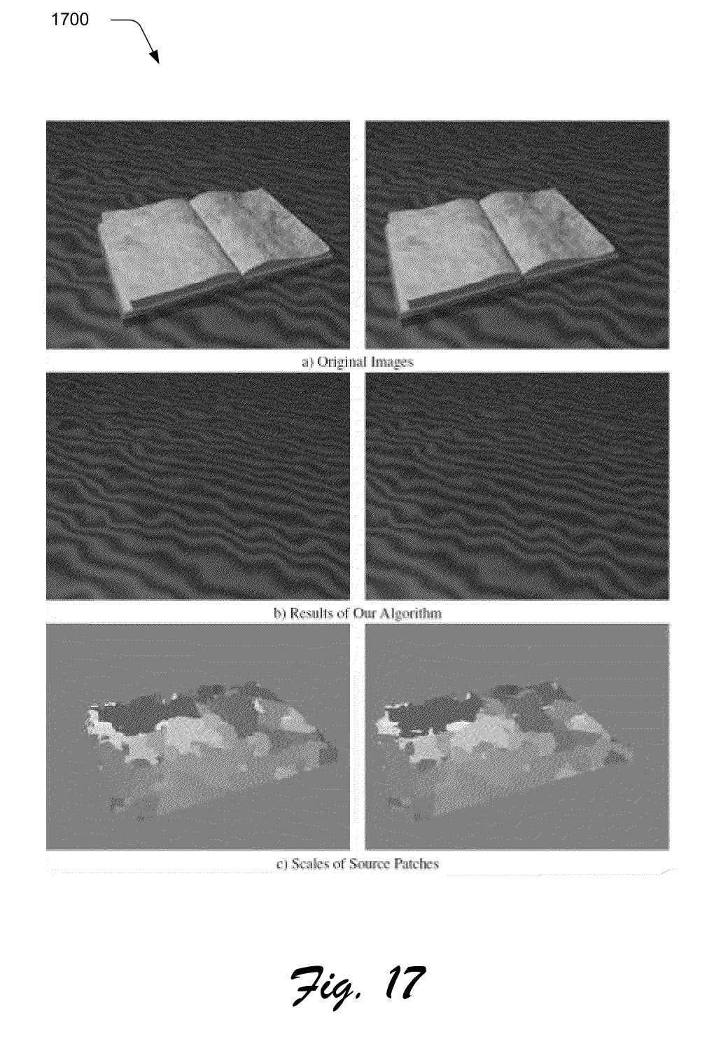

These flat source regions, which may be present in the image, can be artificially introduced by picking scaled source patches that are then upsampled, as demonstrated in the example 1700 of FIG. 17. When upsampling, or enlarging, discrete digital signals (such as digital photographs), high-frequency information is lost. This technique results in blurred texture when applied to digital images. This is evident when viewing a small resolution photo in any photo viewing application with the zoom turned all the way up. If the source is upsampled enough, patches of even the most textured regions will become flat and featureless. This is what happens when the patch-matching algorithm attempts to draw from very small scales.

To address this challenge, the algorithm may be configured to give preference to draw from non-scaled and down-sampled patches. This may be accomplished by including an additional cost term in the distance metric as follows:

Dist(s,t)=Dist_{rgb}(s,t)+λ_{d}Dist_{d}(s,t)+λ_{c}cost(φₓ,φ_{y})

where “Dist(s, t)” is the sum squared difference between the specified channel(s), “λ” is a scale factor for the specified term, and “φₓ” and “φ_{y}” are the directional scale factors between patches “s” and “t” in the “x” and “y” directions, respectively. A value of “cost(φₓ, φ_{y})” may be defined as follows:

$$cost ( {φ}_{x} , {φ}_{y} ) = \{ \begin{matrix}∞ & if {φ}_{x} > {φ}_{ma x} or {φ}_{y} > {φ}_{ma x} \\ ( \frac{{e}^{\frac{[ \text{?} - \text{?} ] - [ \text{?} - 1 ]}{[ \text{?} - 1 ]}} - 1}{\text{?} - 1} ) & \begin{matrix}if {φ}_{ma x} >= {φ}_{x} > 1 or \\ {φ}_{ma x} >= {φ}_{{ }_{y}} > 1\end{matrix} \\ 0 & otherwise\end{matrix} \\ \text{?} \text{indicates text missing or illegible when filed}$$

where “φₘₐₓ” is the maximum allowed up sample factor. In this way, any patches with up-sample factors greater than the maximum allowed scale factor are disallowed and penalized on an exponential scale in comparison to any up-sample factor within the accepted range. This allows the algorithm to still draw from upsampled patches, but builds in a preference for non-scaled, down sampled, and only slightly upsampled patches.

Slight color variations in the resulting fill may be less noticeable than breaks in continuing edges. To address this, gradients within the potential source patches may also be compared to those within their respective target patches. This is implemented by extending the distance metric to include comparison of the gradients as follows:

Dist(s,t)=Dist_{rgb}(s,t)+λ_{d}Dist_{d}(s,t)+λ_{c}cost(φₓ,φ_{y})+λ_{g}Dist_{g}(∇s,∇t)

where “Dist_{g} (∇s, ∇t)” is the sum of the squared difference of the gradients of patches “s” and “t,” and “λg” controls the weight given to this gradient term adding this gradient term to the distance metric boosts the high frequencies of local descriptors. In other words, instead of simply matching color when measuring texture similarity, edges in the texture as well as the variation of the texture are also matched. Thus, edges in the target region may be better completed along with matching of high-frequency content.

### Example Transformations

Using the notation from above, let “S_{L}” and “S_{R}” denote source regions in the left and right images respectively, and similarly let “T_{L}” and “T_{R}” denote respective target regions. Also let “C_{LR}(t)” denote the mapping from patch “t_{L}εT_{L}” centered at (x, y) to the corresponding patch “t_{R}εT_{R}” centered at “(x−D_{L}(x, y), y).” Similarly, let “C_{RL}(t)” denote mapping from patch “t_{R}εT_{R}” centered at (x, y) to the corresponding patch “t_{L}εT_{L}” centered at “(x+D_{R}(x, y), y).” To simplify further notation, “C(t)” is used in the following discussion to denote the stereo-corresponding patch in the other image such that “C(t)=C_{LR}(t)” is used for patches in the left image and “C(t)=C_{RL}(t)” for patches in the right image, respectively.

In the above discussion, optimization of stereo-filling coherence is defined as a minimization of the following objective function:

$${d}_{total} ( {S}_{L} , {S}_{R} , {T}_{L} , {T}_{R} ) = {\sum }_{t ∈ {T}_{L} ⋃ {T}_{R}} {min}_{s ∈ {S}_{L} ⋃ {S}_{R}} d ( s , t ) + {\sum }_{t ∈ {T}_{L} ⋃ {T}_{R}} d ( t , C ( t ) )$$

$$where$$

$${d}^{*} ( s , t ) = {min}_{w ∈ W} [ d ( {w}_{st} ( s ) , t ) + cost ( {w}_{st} ) ]$$

where “W” is a set of warps (i.e., transformations), “wₛₜ” from the source patch to the target patch, and “wₛₜ(s)” is the sampled source patch warped using warp “wₛₜ” based on the relative geometry of the source patch “s” and the target patch “t.” The set of warps may include identity transformation (for same-depth frontoparallel patches), scaling (for frontoparallel patches of differing depths), and generalize homographies (for slanted planar patches).

The “cost(wₛₜ)” term in the above expression biases the use of particular forms of warps. For example, the patch matching algorithm may be biased toward selection of down sampled source patches over upsampled ones as previously described. Similarly, the use of warps that involve extreme deformation of the patch may also be penalized. The stereo coherence term has changed to incorporate potential foreshortening between the two views. This is done by sampling “C(t)” in a manner similar to how the source patches are sampled by iterating over the target patch “t” and adding the disparity at that pixel. Since the objective function stays the same other than warping the source patches, the algorithm may likewise stay the same other than similarly incorporating these warped source patches. That is, the basic energy/magnitude strategy of updating the NNF then blending the patches may remain the same.

Source Patch Sampling

Similar to the patch match algorithm described above, upright rectangular (e.g., square) patches may be matched in the target regions to transformed patches in the source region. Using the notation of the patch matching algorithm above, let “f: R²→R²” denote a nearest-neighbor field using absolute coordinates.

Given a target patch “t” with center (or corner, or so on) “t_{c}” and source patch “s” with center (or corner, or so on) “s_{c}”, let “wₛₜ” denote a geometric transformation that is to be applied to target patch “t” to correctly match pixels in a source patch “s” given a known relative three dimensional geometry between the neighborhoods surrounding “t_{c}” and “s_{c}.” Note, that “wₛₜ” does not include a translation between the source and target positions, but rather the relative local geometry transformation, solely.

To compare patches, a variation on a backward warping algorithm may be employed by iterating over a rectilinear patch “t,” computing the corresponding location in the source patch according to the inverse transformation “wₛₜ⁻¹,” and interpolating the value of the image at that location as follows:

Using the corner as the fiducial point for a patch:

s_{c}←f(t_{c})

d(wₛₜ(s),t)←0

or all offsets “Δp” to pixels in “t” do

Δ\hat{p}←wₛₜ⁻¹(Δp)

vₜ=I(t_{c}+Δp)

vₛ=I(s_{c}+Δ\hat{p})

d(wₛₜ(s),t)←d(wₛₜ(s),t)+∥vₜ−vₛ∥²

end for

As with the patch matching algorithm above, this sampling may be short-cut once the “d(wₛₜ(s), t)” grows to exceed that of the current best match. The set of images values “vₛ” (i.e., “wₛₜ(s)”) may be cached for the current best match to avoid re-computation during blending.

Generalized Homography Warping

Again, using the notation above, the source patch may be warped according to a homography mapping a three dimensional plane on which it appears to a three dimensional plane on which the target patch appears.

Hₛₜ=HₜHₛ⁻¹

where “Hₜ” is the homography that warps the target patch from the assumed plane on which it lies to the camera's imaging plane, and “Hₛ” is a similarly constructed homography for the source patch. The inverse of this homography, which maps target patch coordinates to corresponding source ones for inverse warping, is given by:

Hₛₜ⁻¹=HₛHₜ⁻¹

The absolute positions of the patches (which is accounted for in the position “t_{c}” and “s_{c}−f(t)”) may be separated out by first compensating for these. Let “T_{tc}” be a translation matrix from the target patch position “t_{c}” to the origin (i.e., translate by “−t_{c}”) and similarly let “T_{sc}” be a translation matrix from the source patch position “s_{c}” to the origin (i.e., translate by “−s_{c}”). The inverse warping used for sampling the source patch is then given by the following:

$${w}_{st}^{- 1} = {T}_{{s}_{\text{?}}} {H}_{\text{?}} {H}_{\text{?}}^{- 1} {T}_{{t}_{\text{?}}}^{- 1}$$

$$\text{?} \text{indicates text missing or illegible when filed}$$

The intuition is that the indexed offsets are iterated in the target patch. Applying the transformation expressions above, the target patch index position is translated to an absolute image coordinate using “T_{tc}⁻¹,” the inverse warping “Hₜ⁻¹” is applied to warp from absolute image coordinates to local planar coordinates on the corresponding imaged surface there. The forward warping “Hₛ” is applied to warp from local planar coordinates on the imaged surface to correspond to the absolute image coordinates of the source patch. The absolute image coordinates of the source patch are then translated back to an anchor-relative position within the source patch using “T_{sc}.”

The homographies “Hₜ” and “Hₛ” may be calculated as follows. To calculate the homography that maps patches (which live in two dimensional image coordinates) to corresponding two dimensional planar coordinates on the planes of the image surfaces, the following are defined. Let “p=(x,y)” be the position of a pixel in the image and “P=(Pₓ, P_{y}, P_{z})” be the three dimensional location of the point seen at that pixel location. “P” is given by the following expression:

$$P = \frac{b}{D ( x , y )} [ \begin{matrix}x - {x}_{c} \\ y - {y}_{c} \\ fh\end{matrix} ]$$

where “b” is the camera baseline separation, “f” is the camera's focal length, “h” is the pixel sampling density on the camera's image plane, and again “D(x,y)” is the disparity at position (x,y). An assumption may be made that the optical axis is at the center of the image “x_{c}, y_{c}” and that the pixel aspect ratio is one.

Let “N(p)” be the estimated normal to the plane seen at point “p,” calculated using a weighted least squares fit to the local neighborhood around the point, i.e., the three dimensional coordinates of the points seen in the two dimensional image neighborhood around the point. The weights of these points are based on spatial proximity and the similarity in disparity (and maybe colors) between the neighbors and the point. Let “R” denote the rotation matrix from the plane to the camera based on the local planar coordinates and the normal to the plane “N” as follows:

R=[e₁e₂e₃]

It may be noted that if these vectors are written as the rows of “R,” the rotation from the camera to the plane in the world may be obtained with the rotation from the plane to the camera is the inverse (transpose) of this. The value of “e₃=−N” and the other two directions of the rotation matrix are not constrained other than being orthogonal to “N.” This is analogous to in-plane rotation of the virtual camera. The value of “e₂” may be defined as a “hinge direction” defined by the re-normalized cross product between the normals of the target and source points. By orthogonal construction, “e₁=e₂×e₃.” Because the focal length, pixel density, or baseline separation is unknown, the relative “z” component of the normals is correct up to an unknown proportionality constant “b f h.”

The homography that maps from the imaged position (x,y) of “p” to the local planar surface at “p” may be constructed as follows:

$$H = [ \begin{matrix}fh & 0 & 0 \\ 0 & fh & 0 \\ 0 & 0 & 1\end{matrix} ] [ \begin{matrix}{r}_{11} & {r}_{12} & - {P}_{x} \\ {r}_{21} & {r}_{22} & - {P}_{y} \\ {r}_{31} & {r}_{32} & - {P}_{z}\end{matrix} ]$$

where “rᵢⱼ” is the “i, j-th” element of “R.” This construction may be used to compute “Hₛ” by using “p=s_{c}” and similarly “Hi” by using “p=t_{c}.”

The above expression may be expanded through substitution of “P” from above, the product “f h” appears in each of the elements of the matrix “H” except for the first two elements of the bottom row. Specifically, making this substitution and factoring out “f h” gives:

$$H = fh [ \begin{matrix}{r}_{11} & {r}_{12} & \frac{b}{D ( x , y )} ( x - {x}_{c} ) \\ {r}_{21} & {r}_{22} & \frac{b}{D ( x , y )} ( y - {y}_{c} ) \\ \frac{{r}_{31}}{fh} & \frac{{r}_{32}}{fh} & \frac{b}{D ( x , y )}\end{matrix} ]$$

Thus, as the product “f h” becomes reasonably large, as it does with typical camera configurations, the resulting homographies become nearly affine, as does the composition of one with the inverse of the other. Approximating a resulting composition H” with its affine approximation may be used to produce results similar to a full projective homography.

For both scaling and generalized homographies, the transformation may be determined solely based on scene geometry as determined by correspondence disparities. Accordingly, unlike the patch matching algorithm above, a large search over the parameter space may be avoided. However, it may still be useful to perform local refinement of the initial transformations determined using the approaches of the last two sections. This may be done using random (or if small enough, uniform) sampling of a range around the parameters of these transformations.

For scaling, the scaling ratio may be explored, and it may also be useful to allow non-square aspect ratios and independent refinement of horizontal and vertical scaling. This may be used to handle slight foreshortening along horizontal and/or vertical receding planes with increased robustness over use of generalized homographies. For generalized homographies, each of the eight free parameters need not be treated as independent. Since the homographies are computed based on surface normals, these possible normals may be adjusted. Furthermore, it may be sufficient to hold fixed the normal of the target patch and explore the space of normals for the source patch. Again, for both of these transformation the search may be performed for the space of parameters that are close to the original estimates, and not the full space of possible parameters/transformations.

As noted above, the homography used to map source to target patches under perspective projection may be closely approximated by an affine transformation given. This suggests that if the scale parameter is closely approximated using the scene geometry, the set of other parameters may also be found by iterative (gradient-descent) refinement.

To perform iterative refinement, the transformation matrix “A” is first initialized such that “wₛₜ⁻¹=A” may be expressed as follows:

$$A = [ \frac{{D}_{s}}{{D}_{t}} ]$$

Spatial coherence weighting may be performed in a manner similar to content-aware fill by considering how NNF propagation is performed both here and in the generalized patch matching algorithm above. In regular content aware fill, spatial coherence weighting is performed by counting a number of neighbors “c” whose NNF entries match that of “t_{c}” plus the offset between “t_{c}” and that neighbor. A monotonically increasing function “F(c)” is then applied to it, which may be expressed as follows:

$$weight ( t ) = F ( {\sum }_{n ∈ N ( \text{?} )} δ ( ‖ f ( \text{?} ) - f ( n ) - ( {t}_{c} - \text{?} ) ‖ ) )$$

$$\text{?} \text{indicates text missing or illegible when filed}$$

where “δ(x)” is the Dirac delta function where “δ(x)=1” if “x=0” and “0” otherwise. Extending this to support use of warped patches may be expressed as follows:

$$weight ( t ) = F ( {\sum }_{n ∈ N ( {t}_{c} )} {e}^{- ‖ f ( {t}_{c} ) - f ( n ) - w \text{?} ( {t}_{c} - n ) ) ) ‖} )$$

$$\text{?} \text{indicates text missing or illegible when filed}$$

Note that the above equation for warped patches simplifies to the un-warped example if “wₛₜ” is the identify transformation and the negative exponential is replaced with “δ.”

### Example Results that Include Transformations in Target Region Filling

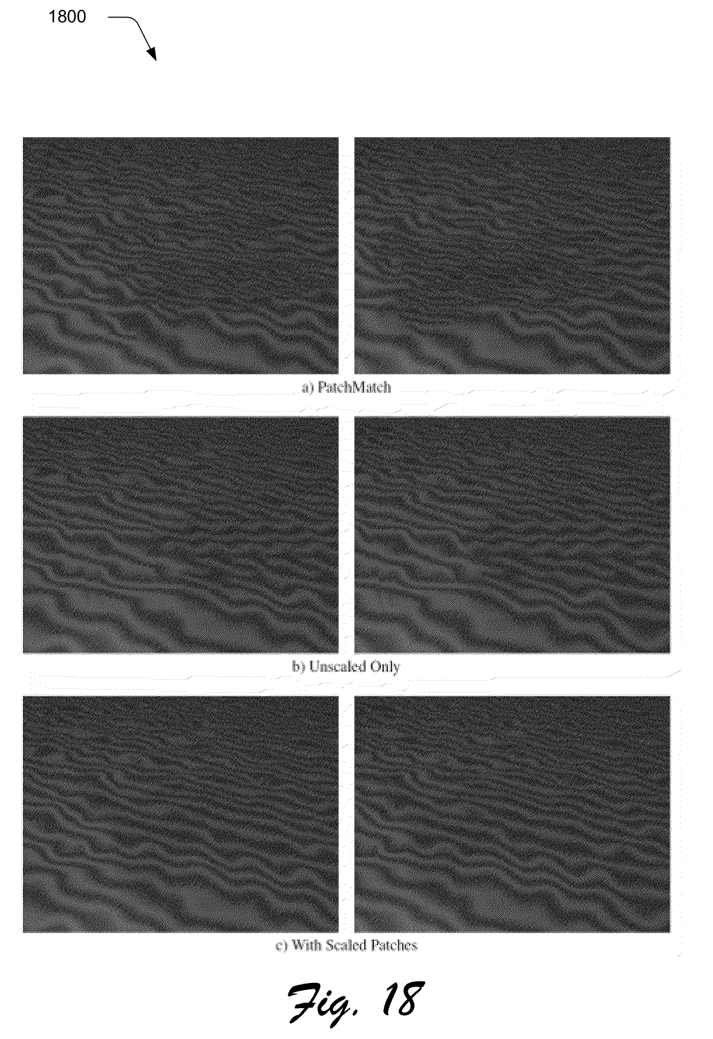

Examples of the results of the transformation extensions above are shown in the examples 1800, 1900, 2000, 2100, 2200, 2300, 2400, 2500 of FIGS. 18-25, respectively. As shown in FIG. 18, results of removal of a book shown in FIGS. 4 and 17 are illustrated which include reproduction of wood grain that is underneath the book. Notice that the direction of the wood grain is followed while appropriately scaling the texture, providing a convincing result. As shown in FIG. 18, results that do not include transformations are also shown in comparison.

The patch-matching algorithm, though not completing the two images in a stereoscopically consistent fashion, does correctly follow the direction of the texture. This is because it can draw liberally from source patches outside the mask. However, it has no concept of depth or scaling and thus copies, for example, smaller-scale texture from more distant patches, which without rescaling looks out of place in the target region.

At the opposite extreme, the algorithm above described without transformations (e.g., scaling), which uses only unscaled patches from the same depth as the respective target patches, produces texture that is appropriately scaled. However, preferring source patches at the same depth as the respective target patches diminishes the possible source patches for the algorithm to draw from and reduces the plausibility of the result. In this case, because the plane to be filled recedes vertically, the algorithm draws same-depth patches from the source regions to the left and right of the target. Because these areas are limited, this leads to undesirable strong repetition of these limited textures in the filled area. However, with the transformation example that permits a search for and blending of source patches, the patches may be scaled appropriately to match the depth of the target region, which may overcome these other limitations.

A visualization in FIG. 17 at “c” shows the relative scales of the source patches blended into the target region. Here, darker gray indicates upsampling, lighter gray indicates downsampling, and mid-level gray (a value of 128) indicates no scaling. There are several things to note about the scales presented in the visualization. First, the algorithm draws from the same scale where it can, such as on the left side of the target region. Second, moving from the edge of the target region to its center, in general, increases the amount of up- or down-sampling.

Since the image is planar and on a slant, target patches towards the center of the target region have depths that are increasingly divergent from the target patches at the edges, particularly parallel to the direction of slant. Since there is little to no texture at the same depth for the algorithm to draw from (i.e., to the left and right of the target region) it is forced to draw from increasingly scaled textures from different depths. Also notice that the algorithm down samples more than up samples, particularly in the center of the target region. This is due to the use of a preference to avoid blurred or washed out results. Thus, the algorithm up-samples texture along the top edge of the target region where the relative scale is close to one, incurring a slight penalty. Finally, the patchiness, i.e., lack of smooth transitions of scales, is simply caused by the nature of the patch-matching algorithm. Both translation and scale are passed when good matches are propagated to neighbors in the search phase,

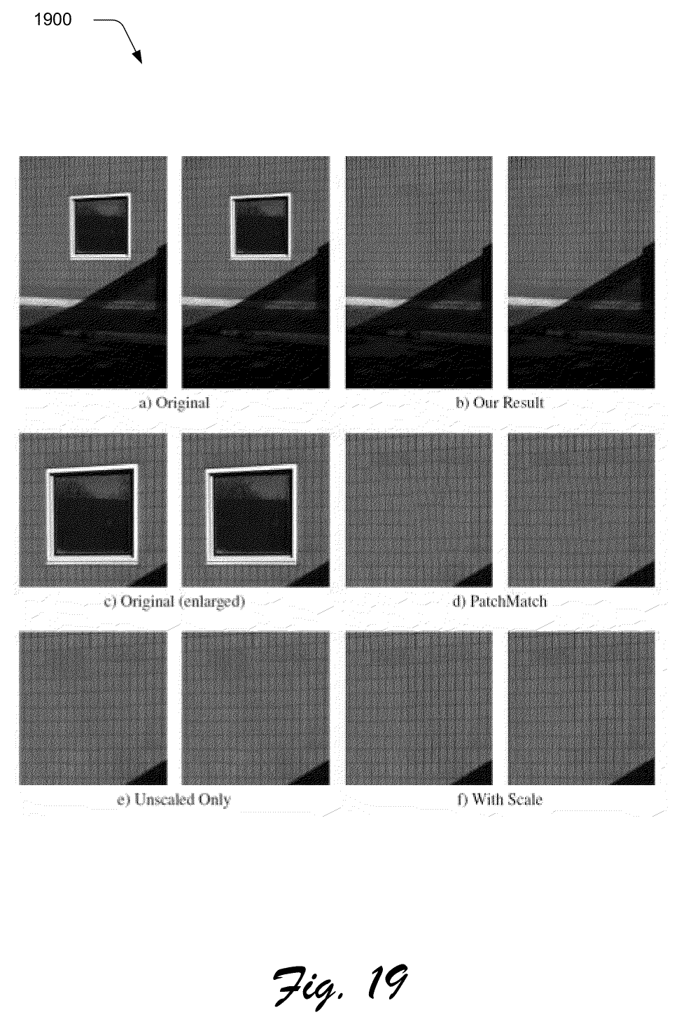

In the example 1900 of FIG. 19, a window is removed along the large brick wall. Notice that the texture of the wall has both a strong direction and strong pattern. Additionally, due to the perspective of the images, the horizontal lines of the bricks are divergent from left to right, so there is limited texture of the correct orientation for the algorithm to draw from. Regardless, the transformation techniques may be used to complete the texture in a visually pleasing way with slight warping of the straight lines of the bricks.

Once again, both the patch-matching algorithm at option “d” and the depth limited algorithm from above at option “e” do not perform as well in this example. The patch-matching algorithm (as before) follows the direction of the texture, but suffers once again from not being able to scale the texture to better fit the target region. As such, it attempts to merge large regions of source material, each with slightly different orientations and spacing of the lines of the texture.

The depth-limited algorithm fairs better as it has ample source material to draw from immediately around the target region. However, due to the divergent nature of the texture, it has little to no source material of the correct orientation. As such, there are several discontinuities and slight warping artifacts introduced on borders where it blends larger regions of source material, (see the right side of the target region). Also of note, is the top left of the target region. Because the algorithm is depth-limited, it has no source material of similar color to draw from that is not better than the source material just above the target region. This drives the algorithm to continue the vertical lines down into the filled region leading to undesirable strong repetition of the limited texture in to filled area. Once again, since the transformation techniques described above are extended to search for and blend source patches that are scaled appropriately to match the depth of the target region, these other limitations may be overcome.

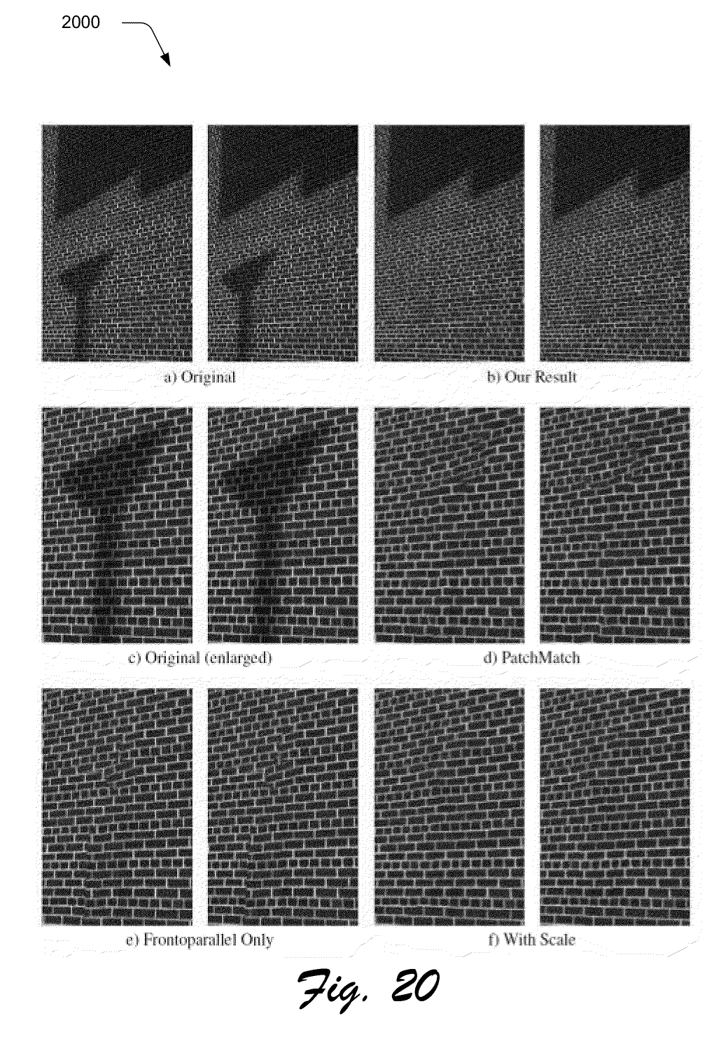

In the example 2000 of FIG. 20, the shadow on the brick wall is removed using the graffiti removal mode discussed above. Notice that this set of images has more severe divergent lines in the region to be completed than the previous example. Also of note is the high frequency of the texture. These two aspects make this a hard image to complete. In particular, the latter aspect makes any inconsistency in the fill immediately apparent to the viewer. That being said, the transformation techniques produce a nice result with slight warping towards the top of the target region.

For this example, both Patch-matching at option “d” and the depth-limited algorithm at option “e” have difficulty addressing the strong directional divergent nature of the brick texture on the wall. In particular, both draw texture into the target region that is not the correct orientation causing visible warping and inconsistencies in the brick pattern, i.e., breaks in the lines. For the patch-matching algorithm, this is because it does not scale the source patches appropriately. For the depth-limited algorithm, this is because it does not have texture with the correct orientation that has similar depth to the target region. The transformation techniques are better able to handle the strong directional divergent nature of the texture by drawing from and appropriately scaling texture from different areas of the image.

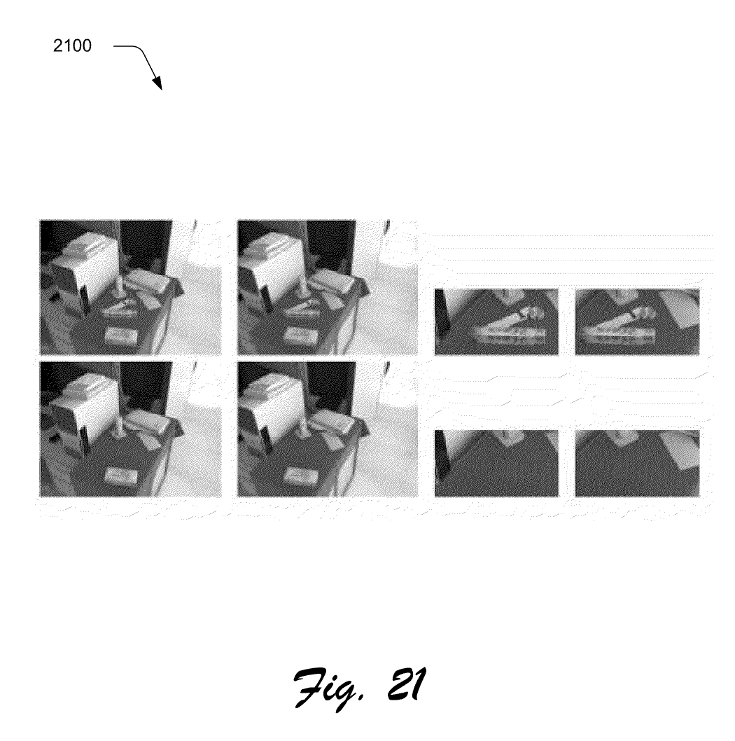

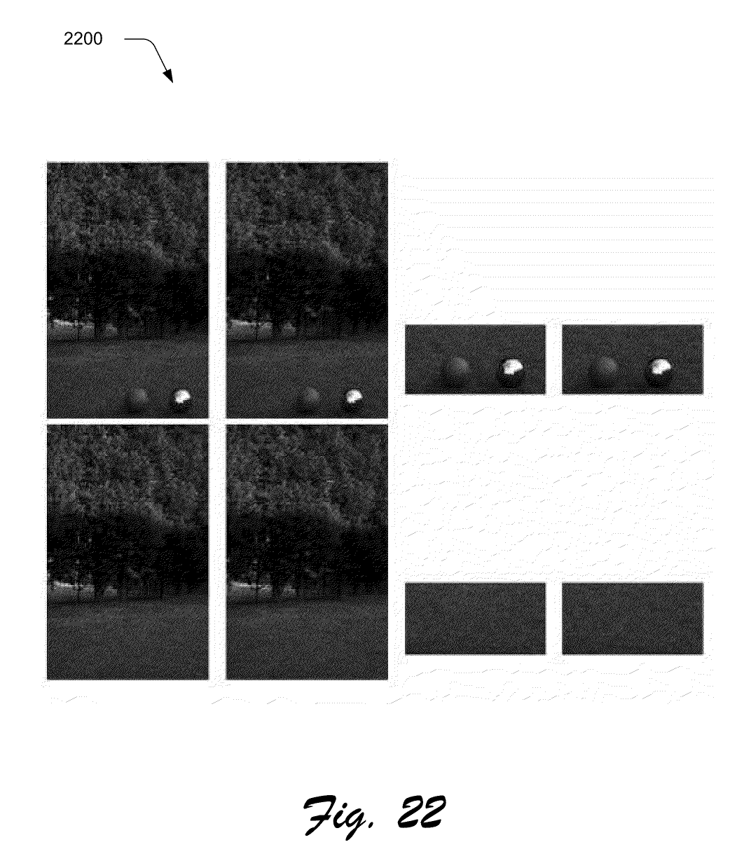

The examples 2100, 2200 of FIGS. 21 and 22 show additional results of the transformation techniques. In FIG. 21, the stapler is removed and the texture completed underneath. In FIG. 22, the diffuse and metallic balls are removed from the forefront of the image. Both of these results are pleasing with only slight inconsistencies or warping in the target region. However, these results include slight improvements over the other techniques as there is plenty of content to draw from at or around the same depth.

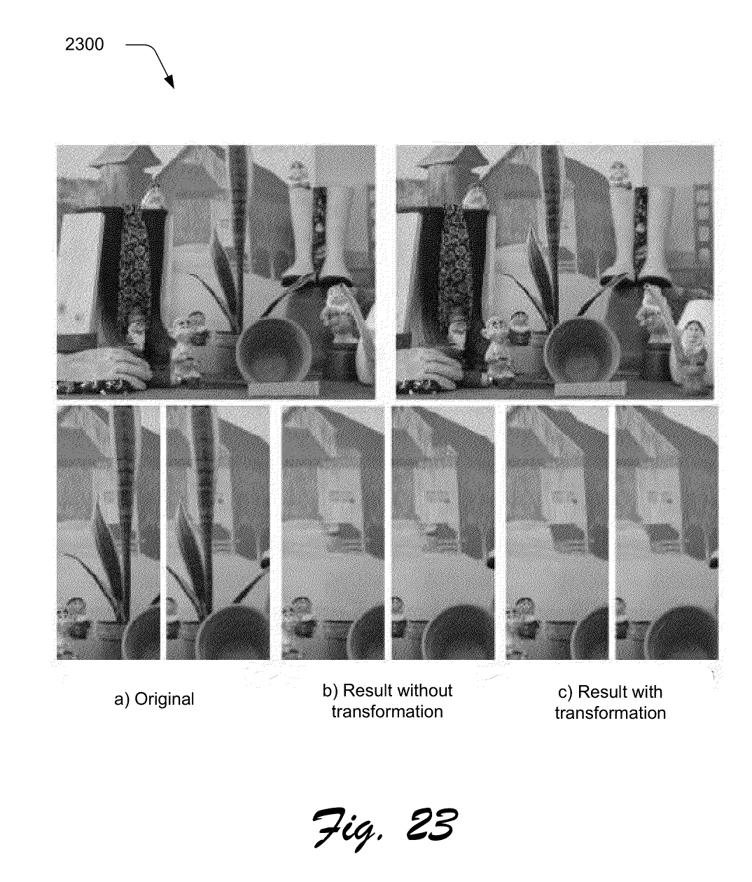

FIGS. 23, 24, and 25 show examples 2300, 2400, 2500 drawn from the depth-limited algorithm that are run with transformations. In these examples, the plant, basketball hoop, and teddy bear are removed, respectively. As is shown in the comparison of each figure, the transformation techniques produces results (c) at least as good, if not better, than the depth-limited algorithm because introduction of depth appropriate scaled source patches does not limit the transformation techniques from drawing non-scaled source patches.

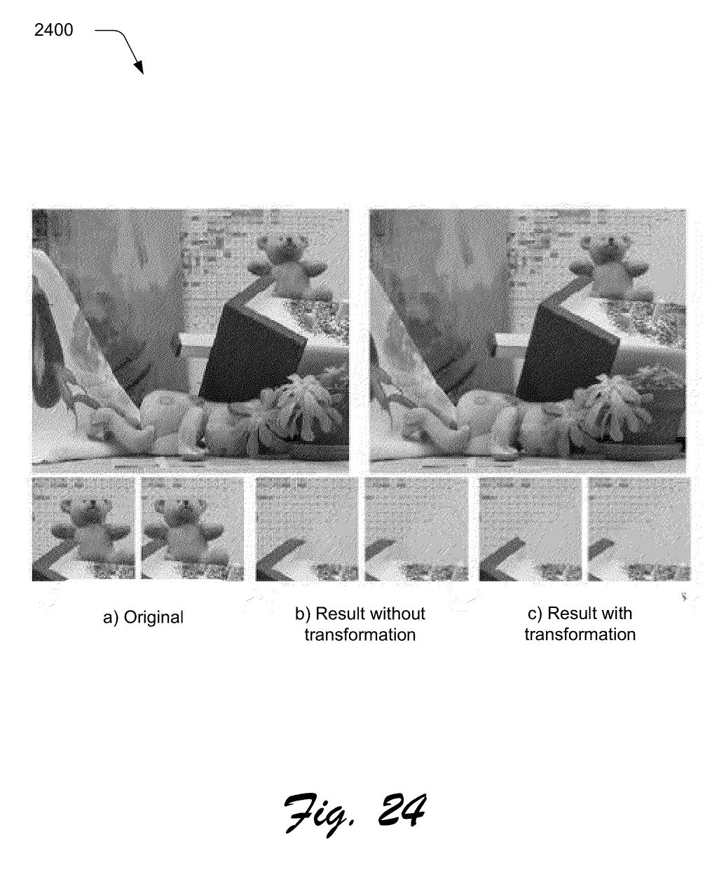

It should be noted that in the teddy bear example 2400 of FIG. 24, the structure of the roof on the birdhouse is reproduced in a more visually pleasing manner than in the results from the depth-limited algorithm at option “b”. The initial poor completion is driven by slight blurring in the disparity map which allows the depth limited algorithm to continue the roof of the birdhouse. Since the transformation techniques are not depth limited, these techniques are not as fragile to blurring in the disparity map, and as such do not continue the roof of the birdhouse beyond the limits of the disparity maps.

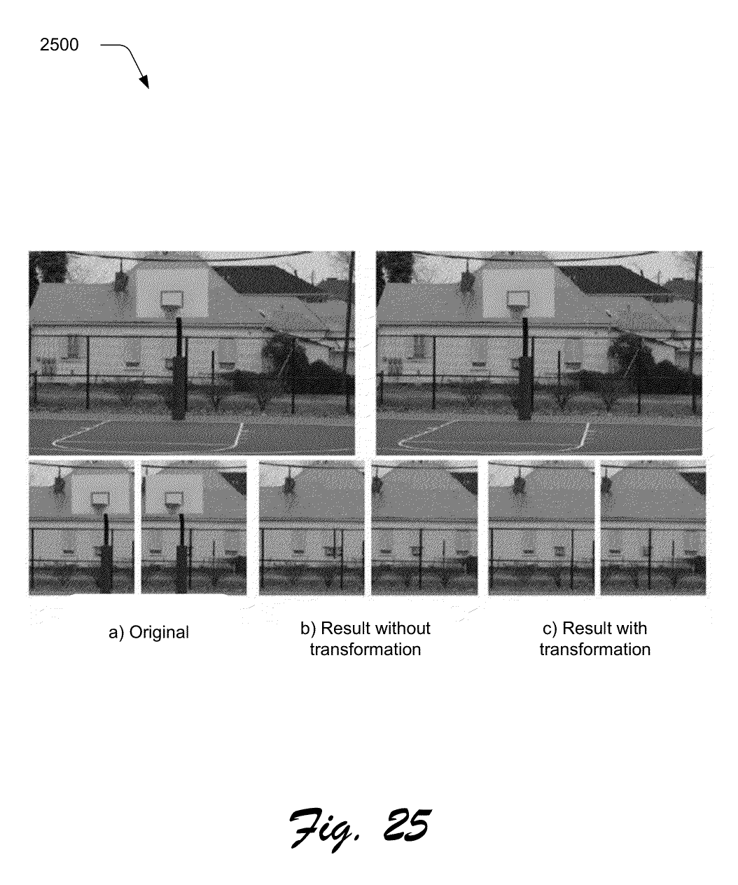

It should also be noted that adding the gradient term in the distance metric has driven some of the other additional improvements. In particular, this is evident in FIGS. 23 and 24. In FIG. 23, where the plant is removed, the line of the roof shows better completion along the front face of the barn. In FIG. 25, where the basketball hoop is removed, the texture of roof is completed by continuing the line between the light and dark portions of the roof, whereas the other results do not.

This discussion describes techniques that may be used to extend a depth-limited, frontoparallel, stereo-aware, patch-matching algorithm to be able to search for and blend source patches scaled appropriately to match the depth of the target region. A cost term is introduced to a distance metric to give preference to non-scaled and down-sampled source patches, as well as incorporate a gradient-based distance term to better complete edges in the target region. The results of these extensions still demonstrate stereo-consistency of the completed regions as well as extend the class of images the algorithm can complete in a visually pleasing fashion.

In the above example an assumption is made that the patches are front facing. This may limit the ability of the algorithm to accurately reproduce texture on planes when drawing from other non-parallel planes in the scene. However, since a determination of the relative 3D structure (up to some unknown scale factor) of an scene in stereo images may be determined, normals of the surfaces in the scene may be approximated. These normals lend themselves toward computation of patch-to-patch homography transformations and may be used to further extend the potential source patches the algorithm can draw from. An example of this extension may involve transforming the texture on one side of a building (according to the 3D structure of the scene) to fit a target region on another (i.e., the corner of a building).

### Example Procedures

The following discussion describes target region filling techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-7 and 9-24.

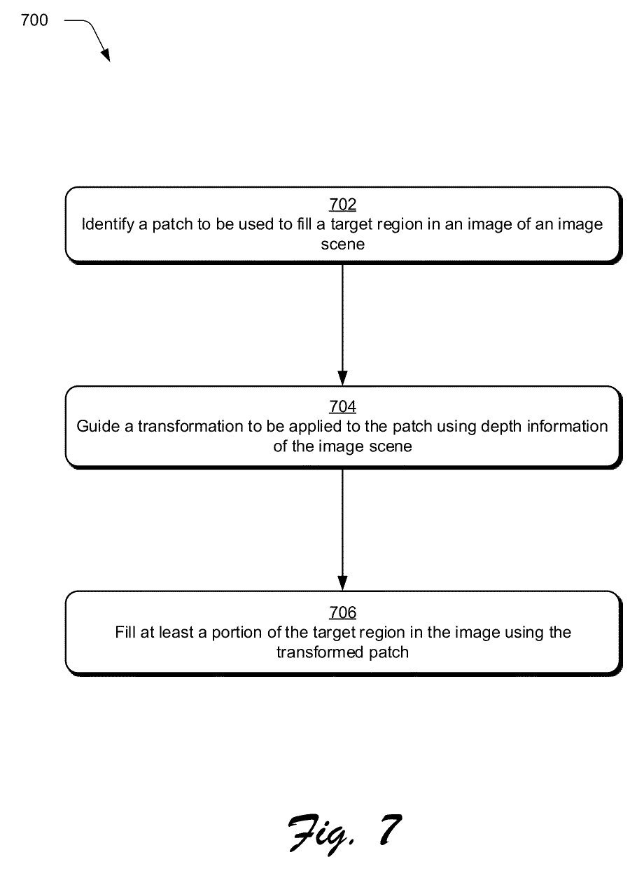

FIG. 7 depicts a procedure 700 in an example implementation in which disparities are used to guide a transformation to be used to fill at least a part of a target region of an image. A patch to be used to fill a target region in an image of an scene is identified (block 702). For example, a search may be performed in an image for source patches as described above that may be utilized to fill a portion of a target region, such as a hole formed through object removal.

A transformation to be applied to the patch is guided using depth information of the scene (block 704). A variety of different transformations may be employed, such as scaling which may include both upscaling and downscaling. Uniform and non-uniform scaling may also be performed as described above.

At least a portion of the target region in the image is filled using the transformed patch (block 706). The transformed patch, as shown in FIGS. 16-25, may thus have a texture that is scaled to approximate a scale of a target region, thereby completing the target region in a visually pleasing manner.

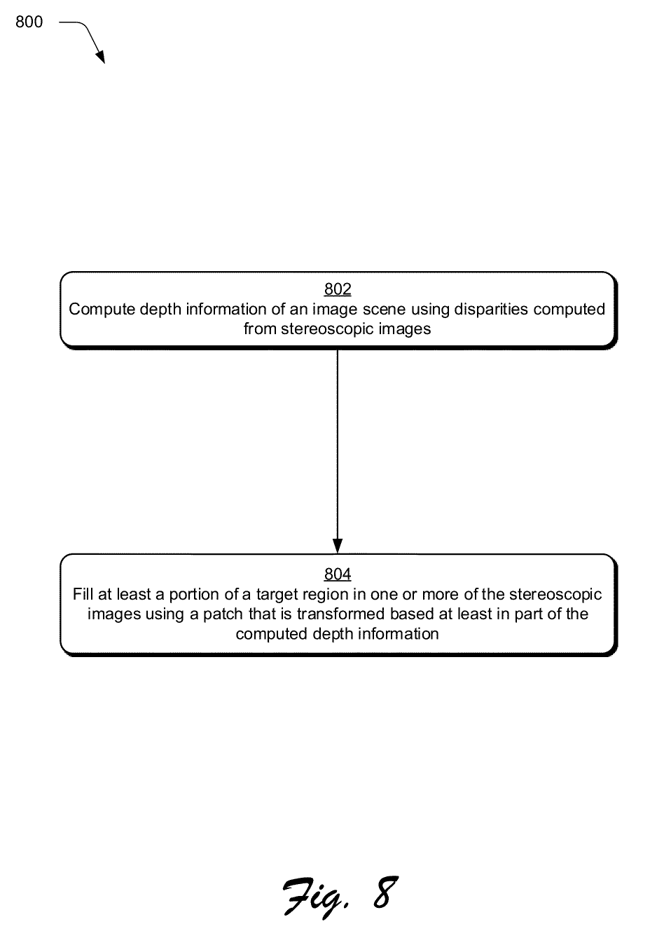

FIG. 8 depicts a procedure 800 in an example implementation in which disparities are used to guide a transformation to be used to fill at least a part of a target region of an image. Depth information of an scene is computed using disparities computed from stereoscopic images (block 802). As above, the disparities may be utilized to compute depth information which is usable to identify a three dimensional structure of the scene.

At least a portion of a target region in one or more of the stereoscopic images is filled using a patch that is transformed based at least in part of the computed depth information (block 804). The depth information, for instance, may be utilized to compute a scale which may include non-uniform scales, such as to address foreshortening of the object in the image. A variety of other examples are also contemplated without departing from the spirit and scope thereof.

### Example System and Device

FIG. 26 illustrates an example system generally at 2600 that includes an example computing device 2602 that is representative of one or more computing systems and/or devices that may implement the various techniques described herein. This is illustrated through inclusion of the image processing module 118, which may be configured to process image data, such as image data captured by an image capture device 104. The computing device 2602 may be, for example, a server of a service provider, a device associated with a client (e.g., a client device), an on-chip system, and/or any other suitable computing device or computing system.

The example computing device 2602 as illustrated includes a processing system 2604, one or more computer-readable media 2606, and one or more I/O interface 2608 that are communicatively coupled, one to another. Although not shown, the computing device 2602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 2604 is representative of functionality to perform one or more operations using hardware. Accordingly, the processing system 2604 is illustrated as including hardware element 2610 that may be configured as processors, functional blocks, and so forth. This may include implementation in hardware as an application specific integrated circuit or other logic device formed using one or more semiconductors. The hardware elements 2610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 2606 is illustrated as including memory/storage 2612. The memory/storage 2612 represents memory/storage capacity associated with one or more computer-readable media. The memory/storage component 2612 may include volatile media (such as random access memory (RAM)) and/or nonvolatile media (such as read only memory (ROM), Flash memory, optical disks, magnetic disks, and so forth). The memory/storage component 2612 may include fixed media (e.g., RAM, ROM, a fixed hard drive, and so on) as well as removable media (e.g., Flash memory, a removable hard drive, an optical disc, and so forth). The computer-readable media 2606 may be configured in a variety of other ways as further described below.

Input/output interface(s) 2608 are representative of functionality to allow a user to enter commands and information to computing device 2602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 2602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 2602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2610 and computer-readable media 2606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 2610. The computing device 2602 may be configured to implement particular instructions and/or functions corresponding to the software and/or hardware modules. Accordingly, implementation of a module that is executable by the computing device 2602 as software may be achieved at least partially in hardware, e.g., through use of computer-readable storage media and/or hardware elements 2610 of the processing system 2604. The instructions and/or functions may be executable/operable by one or more articles of manufacture (for example, one or more computing devices 2602 and/or processing systems 2604) to implement techniques, modules, and examples described herein.

The techniques described herein may be supported by various configurations of the computing device 2602 and are not limited to the specific examples of the techniques described herein. This functionality may also be implemented all or in part through use of a distributed system, such as over a “cloud” 2614 via a platform 2616 as described below.

The cloud 2614 includes and/or is representative of a platform 2616 for resources 2618. The platform 2616 abstracts underlying functionality of hardware (e.g., servers) and software resources of the cloud 2614. The resources 2618 may include applications and/or data that can be utilized while computer processing is executed on servers that are remote from the computing device 2602. Resources 2618 can also include services provided over the Internet and/or through a subscriber network, such as a cellular or Wi-Fi network.

The platform 2616 may abstract resources and functions to connect the computing device 2602 with other computing devices. The platform 2616 may also serve to abstract scaling of resources to provide a corresponding level of scale to encountered demand for the resources 2618 that are implemented via the platform 2616. Accordingly, in an interconnected device embodiment, implementation of functionality described herein may be distributed throughout the system 2600. For example, the functionality may be implemented in part on the computing device 2602 as well as via the platform 2616 that abstracts the functionality of the cloud 2614.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computing devices, the method comprising:
identifying a patch to be used to fill a target region in an image of a scene;
guiding a transformation to be applied to the patch using depth information of the scene; and
filling at least a portion of the target region in the image using the transformed patch.

2. A method as described in claim 1, wherein the depth information is obtained using disparity information computed from a stereoscopic pair of images that includes the image.

3. A method as described in claim 1, wherein the depth information is obtained from one or more depth sensors.

4. A method as described in claim 1, wherein the identifying is performed to give preference to a patch that is to be downscaled or non-scaled as opposed to a patch that is to be upscaled.

5. A method as described in claim 1, wherein the identifying is based at least in part on the depth information of the scene.

6. A method as described in claim 1, wherein the identifying is performed using a similarity metric based at least in part on texture.

7. A method as described in claim 1, wherein the transformation includes performing a warping according to a homography.

8. A method as described in claim 7, wherein the homography maps a three dimensional plane on which a source patch appears to a three dimensional plane on which the patch that is to be used to fill the target region appears.

9. A method as described in claim 1, wherein the guiding includes use of three dimensional structure computed from the depth information of the scene.

10. A method as described in claim 1, wherein the identifying includes comparison of gradients of source patches to those within respective target patches used to fill the target region.

11. A method as described in claim 1, wherein the transformation of the patch includes scaling.

12. A method as described in claim 11, wherein the scaling is performed such that constant scaling transformation scales in x and y directions, differently.

13. A method as described in claim 11, wherein the scaling is uniform in x and y directions.

14. A method as described in claim 11, wherein the scaling is configured to address foreshortening along planes of the image.

15. A method as described in claim 11, wherein the scaling is performed by using a ratio of disparities between the patch and the target region.

16. A system comprising:
at least one module implemented at least partially in hardware, the at least one module configured to compute depth information of an scene using disparities computed from stereoscopic images;
one or more modules implemented at least partially in hardware, the one or more modules configured to fill at least a portion of a target region in one or more of the stereoscopic images using a patch that is transformed based at least in part of the computed depth information.

17. A system as described in claim 16, wherein the transformation includes performing a warping according to a homography that maps a three dimensional plane on which a source patch appears to a three dimensional plane on which the patch that is to be used to fill the target region appears.

18. A system as described in claim 16, wherein the patch is transformed using scaling that includes uniform or non-uniform scaling.

19. One or more computer-readable storage media comprising instructions stored thereon that, responsive to execution by one or more computing devices, cause the one or more computing devices to perform operations comprising:
guiding a transformation to be applied to a patch using depth information of an scene; and
filling at least a portion of a target region in an image of the scene using the transformed patch.

20. One or more computer-readable storage media as described in claim 19, wherein the transformation includes scaling, rotation, or sheering.
